(19) United States
(12) Patent Application Publication
(10) Pub. No.: US 2026/0107282 A1
(43) Pub. Date: Apr. 16, 2026

(54) INFORMATION FIELD DETERMINATION METHOD, CELL DETERMINATION APPARATUS AND CELL INDICATION APPARATUS

(71) Applicant: BEIJING XIAOMI MOBILE SOFTWARE CO., LTD., Beijing (CN)

(72) Inventors: Shijuan WU, Beijing (CN); Yajun ZHU, Beijing (CN)

(21) Appl. No.: 19/115,610

(22) PCT Filed: Aug. 11, 2023
(86) PCT No.: PCT/CN2023/112778

§ 371 Date: Mar. 26, 2025

(30) Foreign Application Priority Data
Sep. 30, 2022 (WO) PCT/CN2022/123652

(51) Int. Cl. H04W 72/231; H04W 72/12; H04W 76/20

(52) U.S. Cl. CPC H04W 72/231; H04W 72/12; H04W 76/20

(57) ABSTRACT

A method for determining an information field is performed by a terminal, and includes: determining, based on at least one of a predefined mode or configuration signaling, a size of at least one information field in multi-cell downlink control information (MC-DCI) for scheduling multiple cells.

### CROSS REFERENCE TO RELATED APPLICATIONS

This application is a US National Phase of International Application No. PCT/CN2023/112778, filed on Aug. 11, 2023, and claims priority to International Application No. PCT/CN2022/123652 filed on Sep. 30, 2022, the entire contents of both of which are incorporated herein by reference.

### TECHNICAL FIELD

The present disclosure relates to the field of communication technologies, and in particular to a method for determining an information field, a method for determining a cell, a method for indicating a cell, an apparatus for determining an information field, an apparatus for determining a cell, an apparatus for indicating a cell, a communication device, and a computer-readable storage medium.

### BACKGROUND

In the related art, one piece of downlink control information (DCI) in a scheduling cell only allows data of one cell to be scheduled, such as scheduling a physical uplink shared channel (PUSCH) and a physical downlink shared channel (PDSCH). With the gradual fragmentation of frequency resources, the demand for scheduling data of multiple cells at the same time will gradually increase.

### SUMMARY

According to a first aspect of the embodiments of the present disclosure, there is provided a method for determining an information field, performed by a terminal, and including: determining a size of at least one information field in multi-cell downlink control information (MC-DCI) for scheduling multiple cells based on any one of: configuration signaling; a predefined condition; and a size of at least one information field in legacy downlink control information.

According to a second aspect of the embodiments of the present disclosure, there is provided a method for determining a cell, performed by a terminal, and including: determining, based on bit information in multi-cell downlink control information (MC-DCI) for scheduling multiple cells, one or more cells scheduled by a first information field in the MC-DCI.

According to a third aspect of the embodiments of the present disclosure, there is provided a method for determining an information field, performed by a network device, and including: determining a size of at least one information field in multi-cell downlink control information (MC-DCI), for scheduling multiple cells, transmitted to a terminal based on any one of: configuration signaling; a predefined condition; and a size of at least one information field in legacy downlink control information transmitted to the terminal.

According to a fourth aspect of the embodiments of the present disclosure, there is provided a method for determining a cell, performed by a network device, and including: instructing, by bit information in multi-cell downlink control information (MC-DCI) for scheduling multiple scheduled cells for a terminal, the terminal to determine one or more cells scheduled by a first information field in the MC-DCI.

According to a fifth aspect of the embodiments of the present disclosure, there is provided an apparatus for determining an information field, including: a processing module, configured to determine a size of at least one information field in multi-cell downlink control information (MC-DCI) for scheduling multiple cells based on any one of: configuration signaling; a predefined condition; and a size of at least one information field in legacy downlink control information.

According to a sixth aspect of the embodiments of the present disclosure, there is provided an apparatus for determining a cell, including: a processing module, configured to determine, based on bit information in multi-cell downlink control information (MC-DCI) for scheduling multiple cells, one or more cells scheduled by a first information field in the MC-DCI.

According to a seventh aspect of the embodiments of the present disclosure, there is provided an apparatus for determining an information field, including: a processing module, configured to determine a size of at least one information field in multi-cell downlink control information (MC-DCI), for scheduling multiple cells, transmitted to a terminal based on any one of: first configuration signaling; a predefined condition; and a size of at least one information field in legacy downlink control information transmitted to the terminal.

According to an eighth aspect of the embodiments of the present disclosure, there is provided an apparatus for indicating a cell, including: an indication module, configured to instruct, by bit information in multi-cell downlink control information (MC-DCI) for scheduling multiple cells for a terminal, the terminal to determine one or more cells scheduled by a first information field in the MC-DCI.

According to a ninth aspect of the embodiments of the present disclosure, there is provided a system for determining an information field, including a terminal and a network device, where the terminal is configured to perform the method for determining the information field according to the first aspect, and the network device is configured to perform the method for determining the information field according to the third aspect.

According to a tenth aspect of the embodiments of the present disclosure, there is provided a system for determining a cell, including a terminal and a network device, where the terminal is configured to perform the method for determining the cell according to the second aspect, and the network device is configured to perform the method for determining the cell according to the fourth aspect.

According to an eleventh aspect of the embodiments of the present disclosure, there is provided a communication device, including: a processor; and a memory storing computer programs, where the computer programs, when executed by the processor, cause the processor to perform at least one of: the method for determining the information field according to the first aspect, or the method for determining the cell according to the second aspect.

According to a twelfth aspect of the embodiments of the present disclosure, there is provided a communication device, including: a processor; and a memory storing computer programs, where the computer programs, when executed by the processor, cause the processor to perform at least one of: the method for determining the information field according to the third aspect, or the method for determining the cell according to the fourth aspect.

According to a thirteenth aspect of an embodiment of the present disclosure, there is provided a computer-readable storage medium, storing computer programs thereon, where the computer programs, when executed by a processor, cause the processor to perform at least one of: the method for determining the information field according to the first aspect, or the method for determining the cell according to the second aspect.

According to a fourteen aspect of an embodiment of the present disclosure, there is provided a computer-readable storage medium, storing computer programs thereon, where the computer programs, when executed by a processor, cause the processor to perform at least one of: the method for determining the in formation field according to the third aspect, or the method for determining the cell according to the fourth aspect.

### BRIEF DESCRIPTION OF THE DRAWINGS

The following briefly introduces the accompanying drawings of the present disclosure. The accompanying drawings in the following description show only example embodiments of the present disclosure.

FIG. 1 is a flowchart illustrating a method for determining an information field according to an embodiment of the present disclosure.

FIG. 2 is a flowchart illustrating a method for determining an information field according to another embodiment of the present disclosure.

FIG. 3 is a flowchart illustrating a method for determining an information field according to yet another embodiment of the present disclosure.

FIG. 4 is a flowchart illustrating a method for determining an information field according to still another embodiment of the present disclosure.

FIG. 5 is a flowchart illustrating a method for determining an information field according to still another embodiment of the present disclosure.

FIG. 6 is a flowchart illustrating a method for determining an information field according to still another embodiment of the present disclosure.

FIG. 7 is a flowchart illustrating a method for determining an information field according to still another embodiment of the present disclosure.

FIG. 8 is a flowchart illustrating a method for determining a cell according to an embodiment of the present disclosure.

FIG. 9 is a flowchart illustrating a method for determining a cell according to another embodiment of the present disclosure.

FIG. 10 is a flowchart illustrating a method for determining an information field according to an embodiment of the present disclosure.

FIG. 11 is a flowchart illustrating a method for determining a cell according to an embodiment of the present disclosure.

FIG. 12 is a block diagram illustrating an apparatus for determining an information field according to an embodiment of the present disclosure.

FIG. 13 is a block diagram illustrating an apparatus for determining a cell according to an embodiment of the present disclosure.

FIG. 14 is a block diagram illustrating an apparatus for determining an information field according to another embodiment of the present disclosure.

FIG. 15 is a block diagram illustrating an apparatus for determining a cell according to another embodiment of the present disclosure.

FIG. 16 is a block diagram illustrating a device for determining an information field and/or indicating a cell according to an embodiment of the present disclosure.

FIG. 17 is a block diagram illustrating a device for determining an information field and/or determining a cell according to an embodiment of the present disclosure.

### DETAILED DESCRIPTION OF THE EMBODIMENTS

Example embodiments of the present disclosure are described below with reference to the accompanying drawings. Apparently, the described embodiments are some of the embodiments of the present disclosure rather than all of the embodiments. All other embodiments obtained by a person of ordinary skill in the art based on the embodiments of the present disclosure without creative efforts shall fall within the protection scope of the present disclosure.

The terms used in the present disclosure are for the purpose of describing a particular example only, and are not intended to limit the present disclosure. The singular forms such as “a,” “said,” and “the” used in the present disclosure and the appended claims are also intended to include multiple, unless the context clearly indicates otherwise. It will also be understood that as used herein, the term “and/or” is and includes any or all combinations of one or more of the associated listed items.

It is to be understood that although different information may be described using the terms such as “first,” “second,” “third,” etc. in the present disclosure, the information should not be limited to these terms. These terms are used only to distinguish the same type of information from each other. For example, without departing from the scope of the embodiments of the present disclosure, the first configuration signaling may also be referred to as the second configuration signaling, and similarly, the second configuration signaling may also be referred to as the first configuration signaling. Depending on the context, as used herein, the wording “if” may be interpreted as “while . . . ” or “when . . . ” or “in response to a determination”.

For purposes of brevity and ease of understanding, the wordings “greater than” or “less than”, “higher than” or “lower than” are used herein to characterize size relationships. However, for those skilled in the art, it will be understood that the wording “greater than” covers the meaning of “greater than or equal to”, and the wording “less than” covers the meaning of “less than or equal to”. The wording “higher than” covers the meaning of “higher than or equal to”, and the wording “lower than” covers the meaning of “lower than or equal to”.

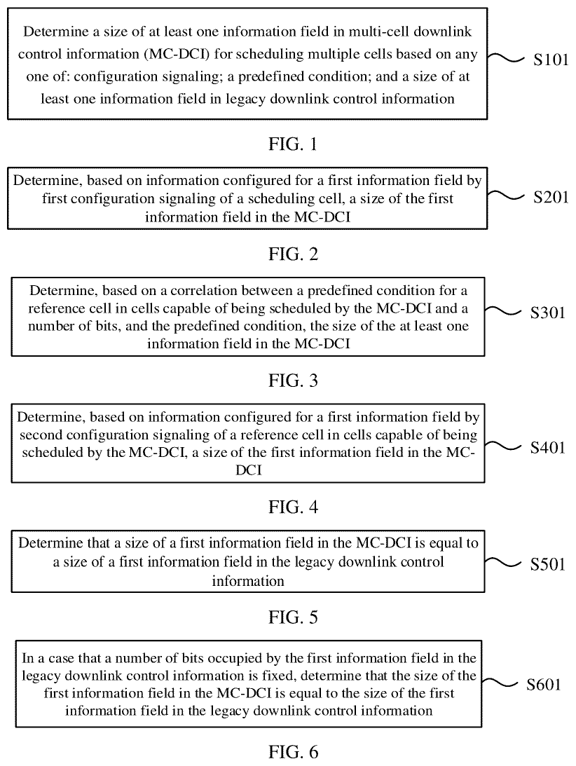

FIG. 1 is a flowchart illustrating a method for determining an information field according to an embodiment of the present disclosure. The method for determining the information field shown in this embodiment may be performed by a terminal. The terminal includes, but is not limited to, a communication device such as a cell phone, a tablet, a wearable device, a sensor, an internet of things (IoT) device, and the like. The terminal may communicate with a network device. The network device includes, but is not limited to a network device (such as a base station, a core network, and the like) in a communication system such as a 4th generation (4G) communication system, 5G communication system, 6G communication system, etc.

As shown in FIG. 1, the method for determining the information field may include the following step S101.

At step S101, a size (i.e., a number of bits occupied, which may also be referred to as a length) of at least one information field (a information field may also be referred to simply as a field) in multi-cell downlink control information (MC-DCI) for scheduling multiple cells is determined based on any one of: configuration signaling; a predefined condition; and a size of at least one information field in legacy downlink control information.

In some embodiments, the MC-DCI may include one or more information fields, and a portion of the information fields need not be applied to all cells actually scheduled by the first downlink control information, but only to a portion of the cells actually scheduled by the first downlink control information, the information field may be called a first information field, and the first information fields may be applied to a portion of the cells actually scheduled by the first downlink control information. That is, the first information field can be the information field contained in the first downlink control information, which is applied to a portion of the cells in the actual scheduling of the first downlink control information. For example, the type of the first information field can be referred to as type1C.

Determining, based on any of the following information, the size of at least one information field in the MC-DCI includes: determining, based on any of the following information, the size of the first information field in the MC-DCI.

The embodiments of the present disclosure propose that the MC-DCI can be used for scheduling multiple cells, specifically scheduling data of multiple cells, such as PUSCH, PDSCH, etc., so that multiple cells can be scheduled by one piece of DCI.

In an embodiment, the terminal can receive the MC-DCI in a scheduling cell (for example, the scheduling cell is a cell in which the terminal is when receiving the MC-DCI). A cell scheduled by the MC-DCI can be called a scheduled cell, which refers to all or portion of the cells capable of being scheduled by the MC-DCI. The cells capable of being scheduled by the MC-DCI can be determined according to the configuration information of the network device or can be determined by a predefined rule, and this is not limited by the present disclosure. It is to be noted that the cells scheduled by the MC-DCI, that is, the scheduled cells, are actually scheduled by the MC-DCI, and the cells capable of being scheduled by is used to represent the capability range of the MC-DCI, and the scheduled cells belong to the cell combination capable of being scheduled by the MC-DCI.

At least one information field is set in the MC-DCI, where the indication information of the first information field in the MC-DCI is configured to schedule one or more of the scheduled cells. The indication information for each of the scheduled cells scheduled by the MC-DCI at the same time is the same. In this case, the mode of scheduling multiple cells by the MC-DCI can be called Type-IA. The first information field does not specifically refer to a certain information field, but refers to any information field in at least one information field.

In the related art, because one piece of DC is only used to schedule one cell, the information field (such as the value of the information field) in the DCI is only applicable for indicating the scheduled cell. For example, illustrated by the example of a bandwidth part indicator as an information field, the bandwidth part indicator information in the DCI in the related art can be configured to indicate whether a scheduled cell switches the bandwidth part (BWP).

Based on this embodiment, the bandwidth part in the MC-DCI indicates the information field can be configured to indicate whether all scheduled cells switch the BWP. In the process, the terminal needs to determine the size of the information field, and determine the value of the information field, to know what information the information field specifically indicates.

In an embodiment, the terminal may receive first configuration signaling transmitted of the scheduling cell, such as radio resource control (RRC) signaling, and determine the size of at least one information field in the MC-DCI according to the first configuration signaling. It is to be noted that in the related art, there is no first configuration signaling for configuring the size of at least one information field in the MC-DCI.

In an embodiment, the terminal can determine a reference cell in multiple scheduled cells capable of being scheduled by the MC-DCI, and receive second configuration signaling in the reference cell, such as RRC signaling. The terminal determines the size of at least one information field in the MC-DCI according to the second configuration signaling of the reference cell, or in a case that there is a correlation between the predefined condition for the reference cell and the size of at least one information field in the MC-DCI, determines the size of at least one information field in the MC-DCI from the correlation according to the predefined condition for the reference cell.

In an embodiment, the terminal can determine the size of at least one information field used in MC-DCI according to the size of at least one information field in the legacy downlink control information, for example, the size of the first information field in the legacy DCI is taken as the size of the first information field in the MC-DCI.

The legacy DCI refers to DCI already specified in the related art, and includes, but is not limited to, DCI 1_0 configured in a common search space (CSS), DCI 0_0 configured in the CSS, DCI 1_0 in a user equipment (UE) specific search space (USS), DCI 0_0, DCI 1_2, DCI 0_2, DCI 1_1, and DCI 0_1 configured in the USS.

According to the embodiments of the present disclosure, the terminal can determine the size of the information field in the MC-DCI based on configuration signaling, the predefined condition and the size of the information field in the legacy DCI, so as to determine the value of the information field, and determine the information indicated by the information field.

FIG. 2 is a flowchart illustrating a method for determining an information field according to another embodiment of the present disclosure. As shown in FIG. 2, determining, based on the configuration signaling, the size of the at least one information field in the MC-DCI includes the following step S201.

At step S201, a size of the first information field in the MC-DCI is determined based on information configured for a first information field by first configuration signaling of a scheduling cell.

In an embodiment, the terminal may receive first configuration signaling transmitted at the scheduling cell, such as RRC signaling, and determine the size or a range of the size of at least one information field in the MC-DCI according to the first configuration signaling. It is to be noted that in the related art, there is no first configuration signaling for configuring the size or a range of the size of at least one information field in the MC-DCI. When the first configuration signaling configures information about the first information field as a range of the size of the first information field, an upper or lower limit value of the range may be used to determine the size of the first information field in the MC-DCI.

For example, the first configuration signaling includes an information element (IE) for indicating the size of at least one information field in the MC-DCI. The information element exists in the configuration information of each of the scheduled cell, and the terminal can determine the size of at least one information field in the MC-DCI according to the information element.

For example, illustrated by the example of a channel state information (CSI) request information field, if the first configuration signaling is configured with the information element (for example, reportTriggerSize), the size of the CSI request information field can be determined according to the report TriggerSize.

For example, illustrated by the example of a bandwidth part indicator information field, if the first configuration signaling is configured with an information element n_{BWP,RRC}, the size of the bandwidth part indicator information field can be determined based on n_{BWP,RRC}.

FIG. 3 is a flowchart illustrating a method for determining an information field according to yet another embodiment of the present disclosure. As shown in FIG. 3, determining, based on the predefined condition, the size of at least one information field in the MC-DCI includes the following step S301.

At step S301, the size of the at least one information field in the MC-DCI is determined based on a correlation between a predefined condition for a reference cell in cells capable of being scheduled by the MC-DCI and a number of bits, and the predefined condition.

In an embodiment, the terminal can determine a reference cell in multiple scheduled cells capable of being scheduled by the MC-DCI, and determines the predefined condition for the reference cell. In a case that there is a correlation between the predefined condition for the reference cell and the size of at least one information field in the MC-DCI, the terminal determines the size of at least one information field in the MC-DCI from the correlation according to the predefined condition for the reference cell.

For example, the predefined condition includes, but is not limited to: the DCI in the reference cell is configured based on the CSS and the DCI is configured based on the USS. For example, illustrated by the example of DCI format 0_0, the size of frequency domain resource assignment (FDRA) field is related to whether the DCI format 0_0 is configured based on the CSS or the USS. If the DCI format 0_0 is configured based on the USS, the size of the FDRA field is related to the number of resource blocks (RBs) contained in the uplink BWP and subcarrier spacing (SCS). If the DCI format 0_0 is configured based on the CSS, the size of the FDRA field is only related to the SCS.

FIG. 4 is a flowchart illustrating a method for determining an information field according to yet another embodiment of the present disclosure. As shown in FIG. 4, determining, based on the second configuration signaling, the size of the at least one information field in the MC-DCI includes the following step S401.

At step S401, a size of the first information field in the MC-DCI is determined based on information configured for a first information field by second configuration signaling of a reference cell in cells capable of being scheduled by the MC-DCI.

In an embodiment, the terminal can determine a reference cell from multiple scheduled cells capable of being scheduled by the MC-DCI, and receive a second configuration signal, such as RRC signal, in the reference cell. Based on the second configuration signal of the reference cell, the terminal can determine the size or the range of size of at least one information field in the MC-DCI. When the second configuration signaling configures information about the first information field as a range of the size of the first information field, an upper or lower limit of the range may be used to determine the size of the first information field in the MC-DCI.

For example, the second configuration signaling includes an IE for indicating the size of at least one information field in the MC-DCI. The information element exists in the configuration signaling of each of the scheduled cell, and the terminal can determine the size of at least one information field in the MC-DCI according to the information element.

For example, illustrated by the example of a CSI request information field, if the second configuration signaling is configured with the information element (for example, reportTriggerSize), the size of the CSI request information field can be determined according to the report TriggerSize.

For example, illustrated by the example of a bandwidth part indicator information field, if the second configuration signaling is configured with an information element n_{BWP,RRC}, the size of the bandwidth part indicator information field can be determined based on n_{BWP,RRC}.

FIG. 5 is a flowchart illustrating a method for determining an information field according to yet another embodiment of the present disclosure. As shown in FIG. 5, determining, based on the size of the at least one information field in the legacy downlink control information, the size of the at least one information field in the MC-DCI includes the following step S501.

At step S501, it is determined that a size of a first information field in the MC-DCI is equal to a size of a first information field in the legacy downlink control information.

In an embodiment, the terminal can determine the size of the first information field in the legacy DCI based on the configuration information of the network device, or determine the size of the first information field in the legacy DCI based on the predefined rule, so as to determine the size of the first information field in the legacy DCI as the size of the first information field in the MC-DCI. That is, it is determined that the size of the same information field in legacy DCI and the MC-DCI is the same.

FIG. 6 is a flowchart illustrating a method for determining an information field according to yet another embodiment of the present disclosure. As shown in FIG. 6, determining that a size of a first information field in the MC-DCI is equal to a size of a first information field in the legacy downlink control information includes the following step S601.

At step S601, in a case that a number of bits occupied by the first information field in the legacy downlink control information is fixed, it is determined that the size of the first information field in the MC-DCI is equal to the size of the first information field in the legacy downlink control information.

In an embodiment, a first information field with a fixed number of bits occupied may be included in the legacy DCI. For example, the size of the identifier for DCI formats is constant at 1 bit, regardless of the configuration signaling and conditions of the cell. In this case, it can be determined that the size of the first information field in the MC-DCI is equal to the size of the first information field in the legacy DCI.

For example, when the size of the identifier for DCI formats field in DCI format1_1 is constant (for example, it is constant at 1 bit), the size of the bandwidth part indicator information field in the MC-DCI can be determined based on the size of the bandwidth part indicator information field in the legacy DCI.

For example, when the size of the hybrid automatic repeat request (HARQ) process number field in DCI format 1_1 is constant (for example, it is constant at 6 bits), the size of the CSI request information field in the MC-DCI can be determined based on the size of the CSI request information field in the legacy DCI.

In addition, in an embodiment, the maximum number of bits that can be occupied by the first information field in the legacy DCI can be determined, and the size of the first information field in the MC-DCI can be determined to be equal to the maximum number of bits that can be occupied by the first information field in the legacy DCI.

For example, if a size of zero power channel state information reference signal (ZP CSI-RS trigger) trigger field in DCI format 1_1 can be 0, 1, 2 bits, it can be determined that the maximum number of bits occupied by the ZP CSI-RS trigger field in the DCI format 1_1 is 2 bits, and the size of the ZP CSI-RS trigger field in the MC-DCI can be determined to be 2.

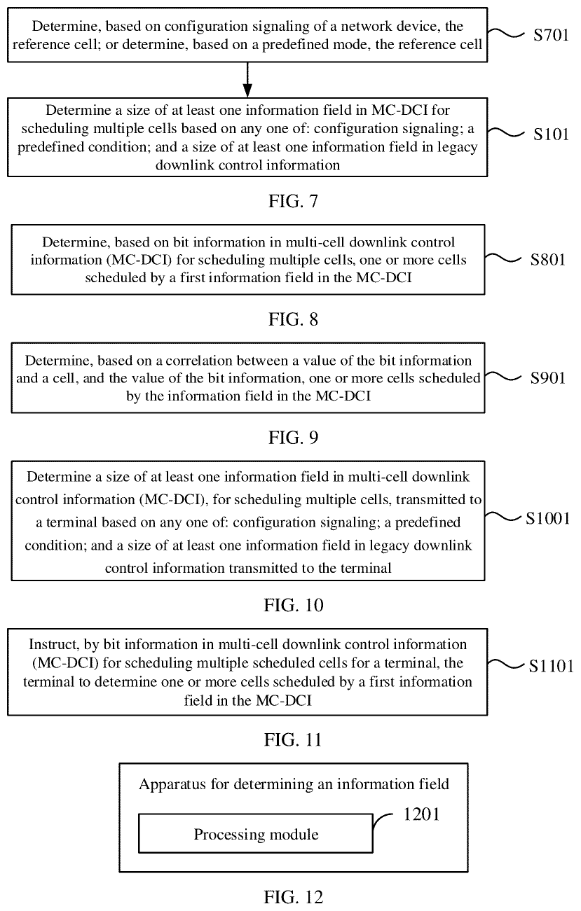

FIG. 7 is a flowchart illustrating a method for determining an information field according to yet another embodiment of the present disclosure. As shown in FIG. 7, the method further includes the following step S701.

At step S701, the reference cell is determined based on the configuration signaling of the network device; or the reference cell is determined based on the predefined mode.

In an embodiment, the terminal can determine a reference cell in the cells capable of being scheduled by the MC-DCI, and the mode for determining the reference cell can be determined based on the configuration signaling of the network device (such as RRC signaling for scheduling cells), or based on a predefined mode, which is not limited in the present disclosure.

The following embodiments illustrate determining, based on predefined mode, the reference cell.

In an embodiment, the predefined mode includes at least one of:
determining an upper limit value of a size of a first information field of each of at least one scheduled cell, and determining a scheduled cell corresponding to a maximum upper limit value as the reference cell;
determining a lower limit value of the size of the first information field of each of the at least one scheduled cell, and determining a scheduled cell corresponding to a minimum lower limit value as the reference cell;
determining an identity of each of the at least one scheduled cell, and determining a scheduled cell with the largest identity as the reference cell; or
determining the identity of each of the at least one scheduled cell, and determining a scheduled cell with the smallest identity as the reference cell.

In an embodiment, when the terminal needs to determine the size of the first information field in the MC-DCI, the terminal can first determine the upper limit value of the size of the first information field in the cells capable of being scheduled by the MC-DCI, where the upper limit value can be determined based on the RRC signaling received in the cells capable of being scheduled by the MC-DCI. Furthermore, the maximum upper limit value can be determined among multiple upper limit values, and the cell, corresponding to the maximum upper limit value, capable of being scheduled by the MC-DCI can be determined as the reference cell.

For example, illustrated by the example of a CSI request information field, the cells capable of being scheduled by the MC-DCI include a cell #1 and a cell #2. The upper limit value of the size of the CSI request information field for the cell #1 is 4, and the upper limit value of the size of the CSI request information field for the cell #2 is 5. Therefore, the cell #2 can be determined as the reference cell, and the size of the CSI request information field in the MCDCI can be determined to be equal to 5.

In an embodiment, when the terminal needs to determine the size of the first information field in the MC-DCI, the terminal can first determine the lower limit value of the size of the first information field in the cells capable of being scheduled by the MC-DCI, where the lower limit value can be determined based on the RRC signaling received in the cells capable of being scheduled by the MC-DCI. Furthermore, the minimum lower limit value can be determined among multiple upper limit values, and the cell, corresponding to the minimum lower limit value, capable of being scheduled by the MC-DCI can be determined as the reference cell.

For example, illustrated by the example of a CSI request information field, the cells capable of being scheduled by the MC-DCI include a cell #1 and a cell #2. The lower limit value of the size of the CSI request information field for the cell #1 is 3, and the lower limit value of the size of the CSI request information field for the cell #2 is 4. Therefore, the cell #1 can be determined as the reference cell, and the size of the CSI request information field in the MCDCI can be determined to be equal to 3.

In an embodiment, when the terminal needs to determine the size of the first information field in the MC-DCI, the terminal can first determine the identities of the cells capable of being scheduled by the MC-DCI, so as to determine the cell corresponding to the largest identity among multiple upper limit values as the reference cell.

For example, illustrated by the example of a CSI request information field, the cells capable of being scheduled by the MC-DCI include a cell #1 and a cell #2. The identity of the cell #1 is 1, and the identity of the cell #2 is 2. The identity with 2 is the largest, therefore, the cell #2 can be determined as the reference cell, and the CSI request information field in the MC-DCI can be determined to be equal to the number of bits occupied by the CSI request information field in the cell #2.

In an embodiment, when the terminal needs to determine the size of the first information field in the MC-DCI, the terminal can first determine the identities of the cells capable of being scheduled by the MC-DCI, so as to determine the cell, corresponding to the smallest identity among multiple upper limit values as the reference cell.

For example, illustrated by the example of a CSI request information field, the cells capable of being scheduled by the MC-DCI include a cell #1 and a cell #2. The identity of the cell #1 is 1, and the identity of the cell #2 is 2. The identity with 1 is the smallest, therefore, the cell #1 can be determined as the reference cell, and the CSI request information field in the MC-DCI can be determined to be equal to the number of bits occupied by the CSI request information field in the cell #1.

In an embodiment, the terminal does not expect an indication value of a first information field in the MC-DCI to be greater than an upper limit value of an indication value of a first information field configured for each of at least one scheduled cell.

It is still possible for network devices to transmit the MC-DCI to the terminals, and the first indication value is greater than the upper limit value of the indication value of the first information field configured for one or more scheduled cells. In this case, the first information field in the MC-DCI may indicate the scheduled cell incorrectly. Therefore, this case can be determined as an error case. In this case, it is possible to choose not to indicate the scheduled cell based on the first information field in the MC-DCI, or to report this case to the network device.

FIG. 8 is a flowchart illustrating a method for determining a cell according to an embodiment of the present disclosure. The method for determining the cell field shown in this embodiment may be performed by a terminal. The terminal includes, but is not limited to, a communication device such as a cell phone, a tablet, a wearable device, a sensor, an internet of things (IoT) device, and the like. The terminal may communicate with a network device. The network device includes, but is not limited to a network device (such as a base station, a core network, and the like) in a communication system such as a 4th generation (4G) communication system, 5G communication system, 6G communication system, etc.

As shown in FIG. 8, the method for determining the cell may include the following step S801.

At step S801, one or more cells scheduled by a first information field in the MC-DCI is determined based on bit information in multi-cell downlink control information (MC-DCI) for scheduling multiple cells.

The embodiments of the present disclosure propose that the MC-DCI can be used for scheduling multiple cells, specifically scheduling data of multiple cells, such as PUSCH, PDSCH, etc., so that multiple cells can be scheduled by one piece of DCI.

In an embodiment, the terminal can receive the MC-DCI in a scheduling cell. A cell scheduled by the MC-DCI can be called a scheduled cell, which refers to all or portion of the cells capable of being scheduled by the MC-DCI. The cells capable of being scheduled by the MC-DCI can be determined according to the configuration information of the network device or can be determined by a predefined rule. At least one information field is set in MC-DCI, where the indication information of the first information field in the MC-DCI is configured to schedule one or more cells (for example, the first information field in MC-DCI is only used to schedule one cell), that is, in this embodiment, determining the one or more cells scheduled by the first information field in the MC-DCI refers to determining the one or more cells actually scheduled by the MC-DCI at the same time. In this case, scheduling multiple cells by the MC-DCI may be referred to as Type-1C. The first information field does not specifically refer to a certain information field, but refers to any information field in at least one information field.

In related art, since one piece of DCI is only used to schedule the cell in which the terminal is located when receiving the DCI, there is no need to determine the cell scheduled by the DCI in a specific way. However, in this embodiment, the MC-DCI is capable of scheduling multiple cells, and the first information field is configured to schedule one or more of the cells capable of being scheduled by the MC-DCI. Therefore, it is necessary to determine which cell or cells the first information field is specifically used to schedule among the scheduled cells. In addition, the reason why the first information field in the MC-DCI is used to schedule one or more cells in the cells capable of being scheduled is because in certain time ranges, only a portion of the cells needs to be scheduled through the first information field, rather than through each information field.

According to the embodiments of the present disclosure, the terminal can determine one or more cells scheduled by the first information field in the MC-DCI based on the bit information in the MC-DCI, so as to accurately determine that the first information field in the MC-DCI is specifically used for scheduling cells in the scheduled cells.

In an embodiment, the bit information is n consecutive bits in the first information field of the MC-DCI, and n is a positive integer. For example, the bit information is from the first bit to the nth bit in the first information field of the MC-DCI, or from the last bit to the nth to last bit in the first information field of the MC-DCI.

For example, n is set to 2, when the bit information is from the first bit to the nth bit in the first information field of the MC-DCI, one or more cells scheduled by the first information field in the MC-DCI is determined based on the first two bits of the first information field in the MC-DCI.

For example, n is set to 3, when the bit information is from the last bit to the nth to last bit in the first information field of the MC-DCI, one or more cells scheduled by the first information field in the MC-DCI is determined by the last bit to the third to last bit of the first information field in the MC-DCI.

FIG. 9 is a flowchart illustrating a method for determining a cell according to another embodiment of the present disclosure. As shown in FIG. 9, determining, based on the bit information in the MC-DCI, one or more cells scheduled by an information field in the MC-DCI includes the following step S901.

At step S901, one or more cells scheduled by the information field in the MC-DCI is determined based on a correlation between a value of the bit information and a cell, and the value of the bit information.

In an embodiment, the terminal may pre-store a correlation between the value of the bit information and the cell. Upon receiving the MC-DCI, the value of the bit information in the MC-DCI can be determined, and the cell corresponding to the value of the bit information in the correlation can be determined as one or more cells scheduled by the information field in the MC-DCI.

For example, one or more cells scheduled by the first information field in the MC-DCI are determined based on the first two bits in the MC-DCI, and the correlation between the value of the first two bits in the MC-DCI and the cell scheduled by the first information field in the MC-DCI is shown in a table 1 below.

TABLE 1

| | Cells scheduled by the first |
|---|---|
| First two bits in the MC-DCI | information field |
| 00 | Cell #1 |
| 01 | Cell #3 |
| 10 | Cell #5 |
| 11 | Cell #6 |

Based on the table 1, the terminal can determine that: when the value of the first two bits in the MC-DCI is 00, the first information field in the MC-DCI is configured to schedule the cell #1; when the value of the first two bits in the MC-DCI is 01, the first information field in MC-DCI is configured to schedule the cell #3; when the value of the first two bits in the MC-DCI is 10, the first information field in the MC-DCI is configured to schedule the cell #5; and when the value of the first two bits in the MC-DCI is 11, the first information field in the MC-DCI is configured to schedule the cell #6. The cells capable of being scheduled by the terminal are a cell #1, a cell #2, a cell #3, a cell #4, a cell #5, and a cell #6. The cells scheduled by the first information field can be a portion of the cells capable of being scheduled by the terminal, such as the cell #1, the cell #3, the cell #5, and the cell #6 among the six cells.

It will be understood that each element in the table 1 exists independently and is listed in the same table as an example, but this does not mean that all elements in this table must exist simultaneously as shown in this table. A value of each element is independent of a value of any other element in the Table 1. It is therefore understood by those skilled in the art that the value of each element in this table 1 is an independent embodiment.

In an embodiment, the correlation between the value of the bit information and the cell includes: a positive correlation and a negative correlation.

There is a positive correlation between the value of the bit information and an identity of the cell. For example, the larger the value of the bit information, the larger the identity, for scheduling the cell, for the first information field in the MC-DCI. For example, when the value of the first two bits in the MC-DCI is 00, 01, 10, or 11, it is indicated that the first information field in the MC-DCI is configured to schedule the cell #1 with the identity 1, the cell #2 with the identity 3, the cell #3 with the identity 5, and the cell #4 with the identity 6.

There is a negative correlation between the value of the bit information and an identity of the cell. For example, the smaller the value of the bit information, the smaller the identity, for scheduling the cell, for the first information field in the MC-DCI. For example, when the value of the first two bits in the MC-DCI is 00, 01, 10, or 11, it is indicated that the first information field in the MC-DCI is configured to schedule the cell #4 with the identity 4, the cell #3 with the identity 3, the cell #3 with the identity 2, or the cell #1 with the identity 1.

In an embodiment, in addition to the embodiment of determining one or more cells scheduled by a first information field in the MC-DCI based on the bit information in the MC-DCI, one or more cells scheduled by the first information field in the MC-DCI may be determined based on a predefined mode. For example, an identity of the scheduled cell may be determined, with the cell with the largest identity being the cell scheduled by the first information field in the MC-DCI, or the cell with the smallest identity being the cell scheduled by the first information field in the MC-DCI.

In some embodiments, the network device may transmit radio resource control (RRC) signaling to the terminal to configure, via the RRC signaling, e.g., as indicated by the information element (IE) MC-DCI-SetofCellsToAddModList in the RRC signaling, the terminal with a first list of cell combinations to which the cells capable of being scheduled by the first downlink control information belong. The first list can include multiple cell combinations, and different cell combinations do not contain the same cell.

In some embodiments, the cells included in different cell combinations in the first list may be different. For example, if a cell combination #1 in the first list includes a cell #1, and other cell combinations in the first list will not include the cell #1.

In some embodiments, as shown in FIG. 3, the network device may indicate a cell combination in the first list to which the cells actually scheduled by the first downlink control information belong. For example, the network device can indicate a cell combination in the first list through an information element (DCI field Scheduled cell combination indicator) in RRC signaling. For example, the first list includes four cell combinations, which are represented by the following four information elements: MC-DCI-setofCells0, MC-DCI-setofCells1, MC-DCI-setofCells2, and MC-DCI-setofCells3. For example, if the cell combination, indicated by the network device, in the first list is MC-DCI-setofCells2, the terminal can determine that this cell combination is a cell combination to which the cells actually scheduled by the first downlink control information belong.

In some embodiments, for the first downlink control information, it can be further divided into the first downlink control information for scheduling the PUSCH, such as MC-DCI 0_3, and the first downlink control information for scheduling the PDSCH, such as MC-DCI 1_3. MC-DCI 0_3 and MC-DCI 0_3 refer to a format of MC-DCI, which can be a newly added format of the downlink control information based on a format of the legacy downlink control information. The legacy downlink control information can refer to downlink control information for scheduling a single cell.

In some embodiments, as shown in FIG. 3, for MC-DCI 0_3, the network device can indicate, through the information element (ScheduledCell-ListDCI-0-3) in the RRC signaling, to the terminal the cell combination to which the cells actually scheduled by MC-DCI 0_3 belong. The cell combination to which the cells actually scheduled by MC-DCI 0_3 belong is in one-to-one correspondence with the cell combination to which the cells actually scheduled by the first downlink control information belong. For example, in the case where the cell combination to which the cells actually scheduled by the first downlink control information indicated by the network device belong is MC-DCI-setofCells2, the terminal can determine, based on ScheduledCell-ListDCI-0-3, the cell combination to which the cells actually scheduled by MC-DCI 0_3 belong.

In some embodiments, as shown in FIG. 3, for MC-DCI 1_3, the network device can indicate, through the information element (ScheduledCell-ListDCI-1-3) in the RRC signaling, to the terminal the cell combination to which the cells actually scheduled by MC-DCI 1_3 belong. The cell combination to which the cells actually scheduled by MC-DCI 1_3 belong is in one-to-one correspondence with the cell combination to which the cells actually scheduled by the first downlink control information belong. For example, in the case where the cell combination to which the cells actually scheduled by the first downlink control information indicated by the network device belong is MC-DCI-setofCells2, the terminal can determine, based on ScheduledCell-ListDCI-1-3, the cell combination to which the cells actually scheduled by MC-DCI 1_3 belong.

In some embodiments, the network device may indicate to the terminal the cell combination that can be scheduled by the first downlink control information. For example, for MC-DCI 0_3, as shown in FIG. 3, the network device may indicate, via the information element (ScheduledCellComboListDCI-0-3) under ScheduledCell-ListDCI-0-3, the cell combination that can be scheduled by the MC-DCI 0_3, e.g., a list of cell combinations. For example, in FIG. 3, the cell combinations that can be scheduled by MC-DCI 0_3 include ScheduledCellCombo0 to ScheduledCellComb15, i.e., sixteen cell combinations, with corresponding set indexes of 0 to 15, respectively.

In some embodiments, the network device may indicate to the terminal a cell combination that the MC-DCI 0_3 actually schedules, and the cell combination may include at least one cell. For example, the network device may indicate to the terminal the cell combination actually scheduled by the MC-DCI 0_3 through the information field indication in the first downlink control information. For example, the network device may indicate to the terminal the cell combination actually scheduled by the MC-DCI 0_3 through scheduled cells indicator information field indication in the first downlink control information. The cell combination actually scheduled by the MC-DCI 0_3 belongs to a list of cell combinations capable of being scheduled by the MC-DCI 0_3 as indicated by ScheduledCellComboListDCI-0-3. For example, in FIG. 3, the cell combination actually scheduled by the MC-DCI 0_3 indicated to the terminal via the scheduled cells indicator is the cell combination (ScheduledCellCombo1) corresponding to an index 1.

The network device, when not indicating a list of cell combinations that can be scheduled by the first downlink control information, for example, ScheduledCellComboListDCI-0-3 is not configured, can indicate, through a frequency domain resource assignment (FDRA) field, the cell combination actually scheduled by the first downlink control information.

In some embodiments, the network device may indicate to the terminal the cell combination that can be scheduled by the first downlink control information. For example, for MC-DCI 1_3, as shown in FIG. 3, the network device may indicate, via the information element (ScheduledCellComboListDCI-1-3) under ScheduledCell-ListDCI-1-3, the cell combination that can be scheduled by the MC-DCI 1_3, e.g., a list of cell combinations. For example, in FIG. 3, the cell combinations that can be scheduled by MC-DCI 1_3 include ScheduledCellCombo0 to ScheduledCellComb15, i.e., sixteen cell combinations, with corresponding set indexes of 0 to 15, respectively.

In some embodiments, the network device may indicate to the terminal a cell combination that the MC-DCI 1_3 actually schedules, and the cell combination may include at least one cell. For example, the network device may indicate to the terminal the cell combination actually scheduled by the MC-DCI 1_3 through the information field indication in the first downlink control information. For example, the network device may indicate to the terminal the cell combination actually scheduled by the MC-DCI 1_3 through scheduled cells indicator information field indication in the first downlink control information. The cell combination actually scheduled by the MC-DCI 1_3 belongs to a list of cell combinations capable of being scheduled by the MC-DCI 13 as indicated by ScheduledCellComboListDCI-1-3. For example, in FIG. 3, the cell combination actually scheduled by the MC-DCI 1_3 indicated to the terminal via the scheduled cells indicator is the cell combination (ScheduledCellCombo1) corresponding to an index 1.

The network device, when not indicating a list of cell combinations that can be scheduled by the first downlink control information, for example, ScheduledCellComboListDCI-1-3 is not configured, can indicate, through a FDRA field, the cell combination actually scheduled by the first downlink control information.

The embodiments of the present disclosure also provide a method for determining an information field, performed by a terminal, and including:
determining a second size of a first information field in first downlink control information for scheduling multiple cells based on at least one of:
a first size of a first information field corresponding to a first reference cell in a cell combination corresponding to the first downlink control information; or
a first size of a first information field corresponding to the second reference cell in a cell combination to which cells corresponding to the first downlink control information belong.

In some embodiments, the first downlink control information may include one or more information fields, and a portion of the information fields need not be applied to all cells actually scheduled by the first downlink control information, but only to a portion of the cells actually scheduled by the first downlink control information. the information field may be called a first information field, and the first information fields may be applied to portion of the cells actually scheduled by the first downlink control information. That is, the first information field can be the information field contained in the first downlink control information, which is applied to a portion of the cells in the actual scheduling of the first downlink control information. For example, the type of the first information field can be referred to as type1C.

In some embodiments, the first information field includes at least one of: a channel state information request (CSI Request) information field, or an uplink shared channel indicator (e.g., UL-SCH indicator) information field.

In some embodiments, for the first reference cell, the terminal can determine a first size of the first information field corresponding to the first reference cell, for example, the first size of the first information field corresponding to each cell can be determined based on the size of the information field in the legacy downlink control information. Illustrated by the example of a first information field including a CSI Request field, for example, the network device may transmit a reportTriggerSize signaling to the terminal to indicate a first size of the CSI Request field corresponding to a cell #1.

In some embodiments, the first reference cell in the cell combination includes at least one of:
a cell, with the largest cell index, in the cell combination; or
a cell, with the smallest cell index, in the cell combination.

For example, the cell combination corresponding to the first downlink control information may include one or more cell combinations. For example, the cell combination corresponding to the first downlink control information includes the cells shown in a table 2.

TABLE 2

| Cell combination | Cells included in the cell combination |
|---|---|
| Cell combination #1 | Cell #1 Cell #2 |
| Cell combination #2 | Cell #2 Cell #4 |

As shown in the table 2, the first downlink control information corresponds to two cell combinations, i.e., a cell combination #1 and a cell combination #2, respectively. The cell combination #1 includes a cell #1 with an index 1, and a cell #2 with an index 2, and the cell combination #2 includes a cell #2 with an index 2 and a cell #4 with an index 4.

Illustrated by the example of a first reference cell including a cell, with the smallest cell index, in the cell combination, the terminal may determine that the cell, with the smallest cell index, in the cell combination corresponding to the first downlink control information is a cell #1, i.e., the cell #1 is a reference cell. A first size of the first information field corresponding to the cell #1 can be determined, e.g., three bits. Further, a second size can be determined based on the first size, for example, the second size is equal to the first size, e.g., the second size is three bits.

Illustrated by the example of a first reference cell including a cell, with the largest cell index, in the cell combination, the terminal may determine that the cell, with the largest cell index, in the cell combination corresponding to the first downlink control information is a cell #4, i.e., the cell #4 is a reference cell. A first size of the first information field corresponding to the cell #4 can be determined, e.g., six bits. Further, a second size can be determined based on the first size, for example, the second size is equal to the first size, e.g., the second size is six bits.

In some embodiments, the second reference cell in the cell combination includes at least one of:
a cell, with the largest cell index, in the cell combination;
a cell, with the smallest cell index, in the cell combination; or
a cell, corresponding to a first information field with the largest size, in the cell combination.

For example, the cell combination to which the cells corresponding to the first downlink control information belong is {1,2,3,4}, i.e., the cell combination includes a cell #1 with an index 1, a cell #2 with an index 2, a cell #3 with an index 3, and a cell #4 with an index 4.

Illustrated by the example of a second reference cell including a cell, with the smallest cell index, in the cell combination, the terminal may determine that the cell, with the smallest cell index, in the cell combination corresponding to the first downlink control information is a cell #1, i.e., the cell #1 is a reference cell. A first size of the first information field corresponding to the cell #1 may be determined, e.g., three bits. Further, a second size can be determined based on the first size, for example, the second size is equal to the first size, e.g., the second size is three bits.

Illustrated by the example of a second reference cell including a cell, with the largest cell index, in the cell combination, the terminal may determine that the cell, with the largest cell index, in the cell combination corresponding to the first downlink control information is a cell #4, i.e., the cell #4 is a reference cell. A first size of the first information field corresponding to the cell #4 can be determined, e.g., six bits. Further, a second size can be determined based on the first size, for example, the second size is equal to the first size, e.g., the second size is six bits.

Since the first downlink control information is configured to schedule multiple cells, and the network device indicates, for each cell in the cell combination to which the cells corresponding to the first downlink control information belong, a first size of the first information field corresponding to the cell, and the first sizes of the first information fields corresponding to different cells may be different. Therefore, it is necessary to clarify how to determine the size of the first information field in the first downlink control information in order to accurately parse the first information field.

According to the embodiments of the present disclosure, the terminal may determine the second size of the first information field in the first downlink control information based on the first size of the first information field corresponding to the first reference cell in the cell combination corresponding to the first downlink control information, or based on the first size of the first information field corresponding to the second reference cell in the cell combination to which the cells corresponding to the first downlink control information belong. Accordingly, for the first information field in the first downlink control information, a second size of the information field may be determined explicitly based on a maximum value of the first size of the first information field corresponding to each cell in the cell combination, so as to accurately parse the first information field based on the second size. It is advantageous to avoid problems caused by not determining that based on the first size of the first information field corresponding to which cell in multiple cells, determining the second size of the first information field in the first control information, in case the first downlink control information schedules multiple cells.

In some embodiments, the cell combination corresponding to the first downlink control information includes at least one of:
a cell combination capable of being scheduled by the first downlink control information; or
a cell combination actually scheduled by the first downlink control information, also referred to as a cell combination scheduled by the first downlink control information.

For example, the cell combination corresponding to the first downlink control information includes a cell combination capable of being scheduled by the first downlink control information. For example, the cell combination capable of being scheduled by the first downlink control information is shown in a table 3 below.

TABLE 3

| Cell combination | Cells included in the cell combination |
|---|---|
| Cell combination #1 | Cell #1 Cell #2 |
| Cell combination #2 | Cell #2 Cell #4 |
| Cell combination #3 | Cell #1 Cell #2 Cell #3 |

As shown in the table 3, the cell combination capable of being scheduled by the first downlink control information includes three cell combinations, i.e., a cell combination #1, a cell combination #2 and a and a cell combination #3. The cell combination #1 includes a cell #1 with an index 1, and a cell #2 with an index 2, the cell combination #2 includes a cell #2 with an index 2 and a cell #4 with an index 4, and the cell combination #3 includes a cell #11 with an index 1, a cell #2 with an index 2 and a cell #3 with an index 3.

Illustrated by the example of a first reference cell including a cell, with the smallest cell index, in the cell combination, the terminal may determine that the cell, with the smallest cell index, in the cell combination capable of being scheduled by the first downlink control information is a cell #1, i.e., the cell #1 is a reference cell. A first size of the first information field corresponding to the cell #1 may be determined, e.g., three bits. Further, a second size can be determined based on the first size, for example, the second size is equal to the first size, e.g., the second size is three bits.

For example, the cell combination corresponding to the first downlink control information includes a cell combination actually scheduled by the first downlink control information. For example, the cell combination capable of being scheduled by the first downlink control information is shown in the table 2.

As shown in the table 2, the first downlink control information actually schedules two cell combinations, i.e., a cell combination #1 and a cell combination #2, respectively. The cell combination #1 includes a cell #1 with an index 1, and a cell #2 with an index 2, and the cell combination #2 includes a cell #2 with an index 2 and a cell #4 with an index 4.

Illustrated by the example of a first reference cell including a cell, with the smallest cell index, in the cell combination, the terminal may determine that the cell, with the smallest cell index, in the cell combination actually scheduled by the first downlink control information is a cell #1, i.e., the cell #1 is a reference cell. A first size of the first information field corresponding to the cell #1 may be determined, e.g., three bits. Further, a second size can be determined based on the first size, for example, the second size is equal to the first size, e.g., the second size is three bits.

In some embodiment, the method for determining the information field further includes:
determining, based on first signaling, a list of the cell combination capable of being scheduled by the first downlink control information; or
determining, based on second signaling, the cell combination actually scheduled by the first downlink control information.

In some embodiments, the network device can transmit first signaling to the terminal to indicate to the terminal a list of cell combinations capable of being scheduled by the first downlink control information. In some embodiments, the network device can transmit second signaling to the terminal to indicate to the terminal a cell combination actually scheduled by the first downlink control information. The specific first signaling and second signaling are not limited by the present disclosure.

For example, the first signaling includes at least one of:
ScheduledCellCombo-ListDCI-0-3; or
ScheduledCellCombo-ListDCI-1-3.

In some embodiments, determining the second size of the first information field in the first downlink control information based on the first size of the first information field corresponding to each cell in the cell combination to which the cell corresponding to the first downlink control information includes:
when the terminal is configured with first signaling, determining a first reference cell in a cell combination corresponding to the first downlink control information for scheduling multiple cells, and determining, based on the first size of a first information field corresponding to the first reference cell, the second size of the first information field in the first downlink control information, where the first signaling is configured to indicate the cell combination corresponding to the first downlink control information.

In some embodiments, determining the second size of the first information field in the first downlink control information based on the first size of the first information field corresponding to each cell in the cell combination to which the cell corresponding to the first downlink control information includes:
when the terminal is not configured with first signaling, determining a second reference cell in a cell combination corresponding to the first downlink control information, and determining, based on the first size of a first information field corresponding to the second reference cell, the second size of the first information field in the first downlink control information, where the first signaling is configured to indicate the cell combination corresponding to the first downlink control information.

In the case where the terminal is configured with the first signaling, the terminal may determine the cell combination corresponding to the first downlink control information, and the terminal may determine a first reference cell in the cell combination, and the second size of the first information field in the first downlink control information is determined based on the first reference cell, e.g., it is determined that the second size is equal to the size of the first information field corresponding to the first reference cell.

In the case where the terminal is not configured with the first signaling, the terminal cannot determine the cell combination corresponding to the first downlink control information, and the terminal may determine a second reference cell among the cell combination to which the cells corresponding to the first downlink control information belong, and thereby determine a second size of the first information field in the first downlink control information based on the first size of the first information field corresponding to the second reference cell.

The embodiments of the present disclosure also provide a method for determining an information field, performed by a terminal, and including:
determining a reference cell in a cell combination to which cells corresponding to the first downlink control information for scheduling multiple cells belong; and
determining, based on a first size of a first information field corresponding to the reference cell, a second size of the first information field in the first downlink control information.

In some embodiments, the first downlink control information may include one or more information fields, and a portion of the information fields need not be applied to all cells actually scheduled by the first downlink control information, but only to a portion of the cells actually scheduled by the first downlink control information. the information field may be called a first information field, and the first information fields may be applied to portion of the cells actually scheduled by the first downlink control information. That is, the first information field can be the information field contained in the first downlink control information, which is applied to a portion of the cells in the actual scheduling of the first downlink control information. For example, the type of the first information field can be referred to as type1C.

In some embodiments, the first information field includes at least one of: a channel state information request (CSI Request) information field, or an uplink shared channel indicator (e.g., UL-SCH indicator) information field.

In some embodiments, for the reference cell, the terminal can determine a first size of the first information field corresponding to the reference cell, for example, the first size of the first information field corresponding to each cell can be determined based on the size of the information field in the legacy downlink control information. Illustrated by the example of a first information field including a CSI Request field, for example, the network device may transmit a reportTriggerSize signaling to the terminal to indicate a first size of the CSI Request field corresponding to a cell #1.

In some embodiments, the reference cell includes at least one of:
a cell, with the largest cell index, in the cell combination; or
a cell, with the smallest cell index, in the cell combination.

For example, the cell combination to which the cells corresponding to the first downlink control information belong is {1,2,3,4}, i.e., the cell combination includes a cell #1 with an index 1, a cell #2 with an index 2, a cell #3 with an index 3, and a cell #4 with an index 4.

Illustrated by the example of a reference cell including a cell, with the smallest cell index, in the cell combination, the terminal may determine that the cell, with the smallest cell index, in the cell combination corresponding to the first downlink control information is a cell #1, i.e., the cell #1 is a reference cell. A first size of the first information field corresponding to the cell #1 may be determined, e.g., three bits. Further, a second size can be determined based on the first size, for example, the second size is equal to the first size, e.g., the second size is three bits.

Illustrated by the example of a reference cell including a cell, with the largest cell index, in the cell combination, the terminal may determine that the cell, with the largest cell index, in the cell combination to which the cells corresponding to the first downlink control information belong is a cell #4, i.e., the cell #4 is a reference cell. A first size of the first information field corresponding to the cell #4 can be determined, e.g., six bits. Further, a second size can be determined based on the first size, for example, the second size is equal to the first size, e.g., the second size is six bits.

Since the first downlink control information is configured to schedule multiple cells, and the network device indicates, for each cell in the cell combination to which the cells corresponding to the first downlink control information belong, a first size of the first information field corresponding to the cell, and the first sizes of the first information fields corresponding to different cells may be different. Therefore, it is necessary to clarify how to determine the size of the first information field in the first downlink control information in order to accurately parse the first information field.

According to the embodiments of the present disclosure, the terminal may determine a reference cell among the cell combination to which the cells corresponding to the first downlink control information for scheduling multiple cells belong, and thereby determine the second size of the first information field in the first downlink control information based on the first size of the first information field corresponding to the reference cell. Accordingly, for the first information field in the first downlink control information, a second size of the information field may be determined explicitly based on a maximum value of the first size of the first information field corresponding to each cell in the cell combination, so as to accurately parse the first information field based on the second size. It is advantageous to avoid problems caused by not determining that based on the first size of the first information field corresponding to which cell in multiple cells, determining the second size of the first information field in the first control information, in case the first downlink control information schedules multiple cells.

In some embodiments, the cell combination corresponding to the first downlink control information includes at least one of:
a cell combination to which cells capable of being scheduled by the first downlink control information belong; or
a cell combination to which cells actually scheduled by the first downlink control information belong.

For example, the cell combination to which the cells corresponding to the first downlink control information belong includes a cell combination to which the cells capable of being scheduled by the first downlink control information belong.

For example, the cell combination to which the cells capable of being scheduled by the first downlink control information belong is {1,2,3,4}, i.e., the cell combination includes a cell #1 with an index 1, a cell #2 with an index 2, a cell #3 with an index 3, and a cell #4 with an index 4.

Illustrated by the example of a reference cell including a cell, with the largest cell index, in the cell combination, the terminal may determine that the cell, with the largest cell index, in the cell combination to which the cells corresponding to the first downlink control information belong is a cell #4, i.e., the cell #4 is a reference cell. A first size of the first information field corresponding to the cell #4 can be determined, e.g., six bits. Further, a second size can be determined based on the first size, for example, the second size is equal to the first size, e.g., the second size is six bits.

For example, the cell combination to which the cells corresponding to the first downlink control information belong includes a cell combination to which the cells actually scheduled by the first downlink control information belong.

For example, the cell combination to which the cells actually scheduled by the first downlink control information belong is {1,2,3}, i.e., the cell combination includes a cell #1 with an index 1, a cell #2 with an index 2, and a cell #3 with an index 3.

Illustrated by the example of a reference cell including a cell, with the largest cell index, in the cell combination, the terminal may determine that the cell, with the largest cell index, in the cell combination to which the cells corresponding to the first downlink control information belong is a cell #3, i.e., the cell #3 is a reference cell. A first size of the first information field corresponding to the cell #3 can be determined, e.g., five bits. Further, a second size can be determined based on the first size, for example, the second size is equal to the first size, e.g., the second size is five bits.

In some embodiment, the method further includes at least one of:
determining, based on first signaling, a list of the cell combination to which cells capable of being scheduled by the first downlink control information belong; or
determining, based on second signaling, the cell combination to which cells actually scheduled by the first downlink control information belong.

In some embodiments, the network device can transmit first signaling to the terminal to indicate to the terminal a list of cell combinations to which the cells capable of being scheduled by the first downlink control information belong. In some embodiments, the network device can transmit second signaling to the terminal to indicate to the terminal a cell combination to which the cells actually scheduled by the first downlink control information belong. The specific first signaling and second signaling are not limited by the present disclosure.

The embodiments of the present disclosure also provide a method for determining an information field, performed by a terminal, and including:
determining, based on a maximum number of bits that can be occupied by the first information field corresponding to the legacy downlink control information, the size of the first information field in the first downlink control information for scheduling multiple cells.

In some embodiments, the first information field includes at least one of: a channel state information request (CSI Request) information field, or an uplink shared channel indicator (e.g., UL-SCH indicator) information field.

In some embodiments, for example, the first information field includes a CSI request field. The actual scheduled cells may be indicated by the scheduled cells indicator field or the frequency domain resource assignment field, and the size of the CSI request field may be determined based on the reportTriggerSize of the cell with the smallest index (e.g., service cell index) in the actual scheduled cells, e.g., the size of the CSI request field may be 0, 1, 2, 3, 4, 5 or 6 bits. The CSI request field is applied to the cell with the smallest index. Therefore, the maximum number of bits that can be occupied by the CSI Request field is 6.

In some embodiments, for example, the first information field includes a UL-SCH indicator field. The value of the UL-SCH indicator field is 1, indicating that the UL-SCH will be transmitted on the PUSCH, and the value of the UL-SCH indicator field is 0, indicating that the UL-SCH will not be transmitted on the PUSCH. Therefore, the maximum number of bits that can be occupied by the UL-SCH indicator field is 1.

In some embodiments, the first downlink control information may include one or more information fields, and a portion of the information fields need not be applied to all cells actually scheduled by the first downlink control information, but only to a portion of the cells actually scheduled by the first downlink control information. the information field may be called a first information field, and the first information fields may be applied to portion of the cells actually scheduled by the first downlink control information. That is, the first information field can be the information field contained in the first downlink control information, which is applied to a portion of the cells in the actual scheduling of the first downlink control information. For example, the type of the first information field can be referred to as type1C.

In some embodiments, the legacy downlink control information refers to downlink control information for scheduling a single cell, such as DCI 0_1, DCI 1_1, etc.

In some embodiments, the first information field corresponding to the legacy downlink control information and the first information field in the first downlink control information may have the same characteristics, such as having the same name, and/or having the same function.

In some embodiments, for example, the first information field includes a CSI Request field. For example, the maximum number of bits that can be occupied by the CSI Request field corresponding to the legacy downlink control information (such as DCI 0_1 for scheduling uplink data of a single cell) is 6. In some embodiments, the network device may indicate, through configuration signaling (such as reportTriggerSize), to the terminal that the actual size of the CSI Request field in the first downlink control information (such as MC-DCI 0_3 for scheduling uplink data of multiple cells) is 6, which means that 6 bits are occupied.

In some embodiments, for example, the first information field includes a UL-SCH indicator field. For example, the maximum number of bits that can be occupied by the UL-SCH indicator field corresponding to the legacy downlink control information (such as DCI 0_1 for scheduling uplink data of a single cell) is 1. In some embodiments, the actual size of the UL-SCH indicator field in the first downlink control information (such as MC-DCI 0_3 for scheduling uplink data of multiple cells) can be determined by combining the number of bits (for example, the number of bits is 1) and a predefined condition. For example, the result can determine that the actual size of the UL-SCH indicator field in the first downlink control information is 1, which means that 1 bit is occupied.

FIG. 10 is a flowchart illustrating a method for determining an information field according to an embodiment of the present disclosure. The method for determining the information field shown in this embodiment can be performed by a network device, which can communicate with a terminal. The network device includes, but is not limited to, a base station (such as a 4G base station, a 5G base station, a 6G base station and the like) in a communication system. The terminal includes, but is not limited to, a communication device such as a mobile phone, a tablet, a wearable device, a sensor, and an IoT device.

As shown in FIG. 10, the method for determining the information field may include step S1001.

At step S1001, a size of at least one information field in multi-cell downlink control information (MC-DCI), for scheduling multiple cells, transmitted to a terminal is determined based on any one of: first configuration signaling; a predefined condition; and a size of at least one information field in legacy downlink control information transmitted to the terminal.

In some embodiments, the MC-DCI may include one or more information fields, and a portion of the information fields need not be applied to all cells actually scheduled by the first downlink control information, but only to a portion of the cells actually scheduled by the first downlink control information, the information field may be called a first information field, and the first information fields may be applied to portion of the cells actually scheduled by the first downlink control information. That is, the first information field can be the information field contained in the first downlink control information, which is applied to a portion of the cells in the actual scheduling of the first downlink control information. For example, the type of the first information field can be referred to as type1C.

Determining, based on any of the following information, the size of at least one information field in the MC-DCI transmitted to the terminal includes: determining, based on any of the following information, the size of the first information field in the MC-DCI transmitted to the terminal.

The embodiments of the present disclosure propose that the MC-DCI can be used for scheduling multiple cells, specifically scheduling data of multiple cells, such as PUSCH, PDSCH, etc., so that multiple cells can be scheduled by one piece of DCI.

In an embodiment, the network device can transmit the MC-DCI to the terminal in a scheduling cell. A cell scheduled by the MC-DCI can be called a scheduled cell, which refers to all or portion of the cells capable of being scheduled by the MC-DCI. The cells capable of being scheduled by the MC-DCI can be determined according to the configuration information of the network device or can be determined by a predefined rule. This is not limited by the present disclosure. It is to be noted that the cells scheduled by the MC-DCI, that is, the scheduled cells, are actually scheduled by the MC-DCI, and the cells capable of being scheduled by is used to represent the capability range of the MC-DCI, and the scheduled cells belong to the cells capable of being scheduled by the MC-DCI.

At least one information field is set in the MC-DCI, where the indication information of the first information field in the MC-DCI is configured to schedule one or more of the scheduled cells. The indication information for each of the scheduled cells scheduled by the MC-DCI at the same time is the same. In this case, the mode of scheduling multiple cells by the MC-DCI can be called Type-IA. The first information field does not specifically refer to a certain information field, but refers to any information field in at least one information field.

In the related art, because one piece of DCI is only used to schedule one cell, the information field (such as the value of the information field) in the DCI is only applicable for indicating the scheduled cell. For example, illustrated by the example of a bandwidth part indicator as an information field, the bandwidth part indicator information in the DCI in the related art can be configured to indicate whether a scheduled cell switches the bandwidth part (BWP).

Based on this embodiment, the bandwidth part in the MC-DCI indicates the information field can be configured to indicate whether all scheduled cells switch the BWP. In the process, the network device needs to determine the size of the information field, and determine the value of the information field, to know what information the information field specifically indicates.

In an embodiment, the network device may transmit the first configuration signaling to the terminal in the scheduling cell, such as radio resource control (RRC) signaling, and determine the size of at least one information field in the MC-DCI according to the first configuration signaling. It is to be noted that in the related art, there is no first configuration signaling for configuring the size of at least one information field in the MC-DCI.

In an embodiment, the network device can determine a reference cell in multiple scheduled cells capable of being scheduled by the MC-DCI, and transmit second configuration signaling to the terminal in the reference cell, such as RRC signaling. The terminal determines the size of at least one information field in the MC-DCI according to the second configuration signaling of the reference cell, or in a case that there is a correlation between the predefined condition for the reference cell and the size of at least one information field in the MC-DCI, determines the size of at least one information field in the MC-DCI from the correlation according to the predefined condition for the reference cell.

In an embodiment, the network device can determine the size of at least one information field used in MC-DCI according to the size of at least one information field in the legacy downlink control information, for example, the size of the first information field in the legacy DCI is taken as the size of the first information field in the MC-DCI.

The legacy DCI refers to DCI already specified in the related art, and includes, but is not limited to, DCI 1_0 configured in a CSS, DCI 0_0 configured in the CSS, DCI 1_0 in a USS, DCI 0_0, DCI 1_2, DCI 0_2, DCI 1_1, and DCI 0_1 configured in the USS.

According to the embodiments of the present disclosure, the network device can determine the size of the information field in the MC-DCI based on the first configuration signaling transmitted to the terminal in the scheduling cell, the second configuration signaling transmitted to the terminal in the reference cell, the predefined condition of the second reference cell and the size of the information field in the legacy DCI, so as to determine the size of the information field in the MC-DCI transmitted to the terminal, and thus determine the value of the information field, and determine the information indicated by the information field.

It is to be noted that the operation performed by the terminal after determining the size of the first information field in the MC-DCI and the operation performed by the network device after determining the size of the first information field in the MC-DCI may be different, but rather corresponding. For example, after determining the size of the first information field in the MC-DCI, the terminal can parse the first information field based on its size, and the network device can configure the first information field in the MC-DCI based on its size, such that the first information field indicates the required information.

In an embodiment, determining the size of at least one information field in the MC-DCI based on the first configuration signaling includes: determining the size of the first information field in the MC-DCI based on the information configured for the first information field in the first configuration signaling.

The network device may transmit the first configuration signaling to the terminal in the scheduling cell, such as radio resource control (RRC) signaling, and determine the size or the range of size of at least one information field in the MC-DCI according to the first configuration signaling. It is to be noted that in the related art, there is no first configuration signaling for configuring the size or a range of the size of at least one information field in the MC-DCI. When the first configuration signaling configures information about the first information field as a range of the size of the first information field, an upper or lower limit of the range may be used to determine the size of the first information field in the MC-DCI.

For example, the first configuration signaling includes an IE for indicating the size of at least one information field in the MC-DCI. The information element exists in the configuration signaling of each of the scheduled cell, and the terminal can determine the size of at least one information field in the MC-DCI according to the information element.

For example, illustrated by the example of a CSI request information field, if the second configuration signaling is configured with the information element (for example, reportTriggerSize), the size of the CSI request information field can be determined according to the report TriggerSize.

For example, illustrated by the example of a bandwidth part indicator information field, if the first configuration signaling is configured with an information element n_{BWP,RRC}, the size of the bandwidth part indicator information field can be determined based on n_{BWP,RRC}.

In an embodiment, determining the size of at least one information field in the MC-DCI based on a predefined condition includes: determining the size of at least one information field in the MC-DCI based on a correlation between the predefined condition and the number of bits, and the predefined condition.

The network device can determine a reference cell in multiple scheduled cells scheduled by the MC-DCI, and determines the predefined condition for the reference cell. In a case that there is a correlation between the predefined condition for the reference cell and the size of at least one information field in the MC-DCI, the terminal determines the size of at least one information field in the MC-DCI from the correlation according to the predefined condition for the reference cell.

For example, the predefined condition includes, but is not limited to: the DC in the reference cell is configured based on the CSS and the DCI is configured based on the USS. For example, illustrated by the example of DCI format 0_0, the size of frequency domain resource assignment (FDRA) field is related to whether the DCI format 0_0 is configured based on the CSS or the USS. If the DCI format 0_0 is configured based on the USS, the size of the FDRA field is related to the number of resource blocks (RBs) contained in the uplink BWP and subcarrier spacing (SCS). If the DCI format 0_0 is configured based on the CSS, the size of the FDRA field is only related to the SCS.

In an embodiment, determining the size of at least one information field in the MC-DCI based on the second configuration signaling includes: determining the size of the first information field in the MC-DCI based on the information configured for the second information field in the first configuration signaling.

The network device can determine a reference cell from multiple scheduled cells scheduled by the MC-DCI, and transmit a second configuration signal, such as RRC signal, to the terminal in the reference cell. Based on the second configuration signal of the reference cell, the terminal can determine the size or the range of size of at least one information field in the MC-DCI. When the second configuration signaling configures information about the first information field as a range of the size of the first information field, an upper or lower limit of the range may be used to determine the size of the first information field in the MC-DCI.

For example, the second configuration signaling includes an IE for indicating the size of at least one information field in the MC-DCI. The information element exists in the configuration signaling of each of the scheduled cell, and the terminal can determine the size of at least one information field in the MC-DCI according to the information element.

For example, illustrated by the example of a CSI request information field, the second configuration signaling is configured with the information element (for example, reportTriggerSize), and the size of the CSI request information field can be determined according to the reportTriggerSize.

For example, illustrated by the example of a bandwidth part indicator information field, if the second configuration signaling is configured with an information element n_{BWP,RRC}, the size of the bandwidth part indicator information field can be determined based on n_{BWP,RRC}.

In an embodiment, determining the size of at least one information field in the MC-DCI based on the size of at least one information field in the legacy downlink control information includes: determining that a size of a first information field in the MC-DCI is equal to a size of the first information field in the legacy downlink control information.

The network device can determine the size of the first information field in the legacy DCI based on the configuration information transmitted to the terminal, or determine the size of the first information field in the legacy DCI based on the predefined rule, so as to determine the size of the first information field in the legacy DCI as the size of the first information field in the MC-DCI. That is, it is determined that the size of the same information field in legacy DCI and the MC-DCI is the same.

In an embodiment, determining that the size of the first information field in the MC-DCI is equal to the size of the first information field in the legacy downlink control information includes: in a case that a number of bits occupied by the first information field in the legacy downlink control information is fixed, determining that the size of the first information field in the MC-DCI is equal to the size of the first information field in the legacy downlink control information.

The first information field with a fixed number of bits occupied may be included in the legacy DCI. For example, the size of the identifier for DCI formats is constant at 1 bit, regardless of the configuration signaling and conditions of the cell. In this case, it can be determined that the size of the first information field in the MC-DCI is equal to the size of the first information field in the legacy DCI.

For example, when the size of the identifier for DCI formats field in DCI format1_1 is constant (for example, it is constant at 1 bit), the size of the bandwidth part indicator information field in the MC-DCI can be determined based on the size of the bandwidth part indicator information field in the legacy DCI.

For example, when the size of the hybrid automatic repeat request (HARQ) process number field in DCI format1_1 is constant (for example, it is constant at 6 bits), the size of the CSI request information field in the MC-DCI can be determined based on the size of the CSI request information field in the legacy DCI.

In addition, in an embodiment, the maximum number of bits that can be occupied by the first information field in the legacy DCI can be determined, and the size of the first information field in the MC-DCI can be determined to be equal to the maximum number of bits that can be occupied by the first information field in the legacy DCI.

For example, if a size of zero power channel state information reference signal (ZP CSI-RS trigger) trigger field in DCI format 1_1 can be 0, 1, 2 bits, it can be determined that the maximum number of bits occupied by the ZP CSI-RS trigger field in the DCI format 1_1 is 2 bits, and the size of the ZP CSI-RS trigger field in the MC-DCI can be determined to be 2.

In an embodiment, the method further includes: instructing the terminal to determine, by the configuration signaling, the reference cell; or determining, by the predefined mode, the reference cell.

In an embodiment, the network device can determine a reference cell in the cells scheduled by the MC-DCI (i.e., the scheduled cells), and the mode for determining the reference cell can be determined based on the configuration signaling of the network device (such as RRC signaling for scheduling cells) transmitted to the terminal, or based on a predefined mode, which is not limited in the present disclosure.

In an embodiment, the predefined mode includes at least one of:
determining an upper limit value of a size of a first information field of each of at least one scheduled cell, and determining a scheduled cell corresponding to a maximum upper limit value as the reference cell;
determining a lower limit value of the size of the first information field of each of the at least one scheduled cell, and determining a scheduled cell corresponding to a minimum lower limit value as the reference cell;
determining an identity of each of the at least one scheduled cell, and determining a scheduled cell with the largest identity as the reference cell; or
determining the identity of each of the at least one scheduled cell, and determining a scheduled cell with the smallest identity as the reference cell.

In an embodiment, when the network device needs to determine the size of the first information field in the MC-DCI, the terminal can first determine the upper limit value of the size of the first information field in the cells capable of being scheduled by the MC-DCI, where the upper limit value can be determined based on the RRC signaling transmitted to the terminal in the cells capable of being scheduled by the MC-DCI. Furthermore, the maximum upper limit value can be determined among multiple upper limit values, and the cell, corresponding to the maximum upper limit value, capable of being scheduled by the MC-DCI can be determined as the reference cell.

For example, illustrated by the example of a CSI request information field, the cells capable of being scheduled by the MC-DCI include a cell #1 and a cell #2. The upper limit value of the size of the CSI request information field for the cell #1 is 4, and the upper limit value of the size of the CSI request information field for the cell #2 is 5. Therefore, the cell #2 can be determined as the reference cell, and the size of the CSI request information field in the MCDCI can be determined to be equal to 5.

In an embodiment, when the network device needs to determine the size of the first information field in the MC-DCI, the terminal can first determine the upper limit value of the size of the first information field in the cells capable of being scheduled by the MC-DCI, where the upper limit value can be determined based on the RRC signaling transmitted to the terminal in the cells capable of being scheduled by the MC-DCI. Furthermore, the minimum lower limit value can be determined among multiple upper limit values, and the cell, corresponding to the minimum lower limit value, capable of being scheduled by the MC-DCI can be determined as the reference cell.

For example, illustrated by the example of a CSI request information field, the cells capable of being scheduled by the MC-DCI include a cell #1 and a cell #2. The lower limit value of the size of the CSI request information field for the cell #1 is 3, and the lower limit value of the size of the CSI request information field for the cell #2 is 4. Therefore, the cell #1 can be determined as the reference cell, and the size of the CSI request information field in the MCDCI can be determined to be equal to 3.

In an embodiment, when the network device needs to determine the size of the first information field in the MC-DCI, the terminal can first determine the identities of the cells capable of being scheduled by the MC-DCI, so as to determine the cell corresponding to the largest identity among multiple upper limit values as the reference cell.

For example, illustrated by the example of a CSI request information field, the cells capable of being scheduled by the MC-DCI include a cell #1 and a cell #2. The identity of the cell #1 is 4, and the identity of the cell #2 is 2. the identity with 2 is the largest, therefore, the cell #2 can be determined as the reference cell, and the CSI request information field in the MC-DCI can be determined to be equal to the number of bits occupied by the CSI request information field in the cell #2.

In an embodiment, when the network device needs to determine the size of the first information field in the MC-DCI, the terminal can first determine the identities of the cells capable of being scheduled by the MC-DCI, so as to determine the cell, corresponding to the smallest identity among multiple upper limit values as the reference cell.

For example, illustrated by the example of a CSI request information field, the cells capable of being scheduled by the MC-DCI include a cell #1 and a cell #2. The identity of the cell #1 is 1, and the identity of the cell #2 is 2. The identity with 1 is the smallest, therefore, the cell #1 can be determined as the reference cell, and the CSI request information field in the MC-DCI can be determined to be equal to the number of bits occupied by the CSI request information field in the cell #1.

In an embodiment, the terminal does not expect an indication value of a first information field in the MC-DCI to be greater than an upper limit value of an indication value of a first information field configured for each of at least one scheduled cell.

It is still possible for network devices to transmit the MC-DCI to the terminals, and the first indication value is greater than the upper limit value of the indication value of the first information field configured for one or more scheduled cells. In this case, the first information field in the MC-DCI may indicate the scheduled cell incorrectly. Therefore, this case can be determined as an error case. In this case, it is possible to choose not to indicate the scheduled cell based on the first information field in the MC-DCI, or to report this case to the network device.

FIG. 11 is a flowchart illustrating a method for determining a cell according to an embodiment of the present disclosure. The method for determining the cell shown in this embodiment can be performed by a network device, which can communicate with a terminal. The network device includes, but is not limited to, a base station (such as a 4G base station, a 5G base station, a 6G base station and the like) in a communication system. The terminal includes, but is not limited to, a communication device such as a mobile phone, a tablet, a wearable device, a sensor, and an IoT device.

As shown in FIG. 11, the method for determining the cell may include the following step S1101.

At step S1101, by bit information in multi-cell downlink control information (MC-DCI) for scheduling multiple scheduled cells for a terminal, the terminal is instructed to determine one or more cells scheduled by a first information field in the MC-DCI.

The embodiments of the present disclosure propose that the MC-DCI can be used for scheduling multiple cells, specifically scheduling data of multiple cells, such as PUSCH, PDSCH, etc., so that multiple cells can be scheduled by one piece of DCI.

In an embodiment, the network device can transmit the MC-DCI to the terminal in a scheduling cell. A cell scheduled by the MC-DCI can be called a scheduled cell, which refers to all or portion of the cells capable of being scheduled by the MC-DCI. The cells capable of being scheduled by the MC-DCI can be determined according to the configuration information of the network device or can be determined by a predefined rule. At least one information field is set in MC-DCI, where the indication information of the first information field in the MC-DCI is configured to schedule one or more cells (for example, the first information field in MC-DCI is only used to schedule one cell), that is, in this embodiment, determining the one or more cells scheduled by the first information field in the MC-DCI refers to determining the one or more cells actually scheduled by the MC-DCI. In this case, scheduling multiple cells by the MC-DCI may be referred to as Type-1C. The first information field does not specifically refer to a certain information field, but refers to any information field in at least one information field.

In related art, since one piece of DCI is only used to schedule the cell in which the terminal is located when receiving the DCI, there is no need to determine the cell scheduled by the DCI in a specific way. However, in this embodiment, the MC-DCI is capable of scheduling multiple cells, and the first information field is configured to schedule one or more of the cells capable of being scheduled by the MC-DCI. Therefore, it is necessary to determine which cell or cells the first information field is specifically used to schedule among the scheduled cells. In addition, the reason why the first information field in the MC-DCI is used to schedule one or more cells in the cells capable of being scheduled is because in certain time ranges, only a portion of the cells needs to be scheduled through the first information field, rather than through each information field.

According to the embodiments of the present disclosure, the network device can instruct, by the bit information in the MC-DCI, the terminal to determine one or more cells scheduled by the first information field in the MC-DCI, such that the terminal can accurately determine that the first information field in the MC-DCI is specifically used for scheduling cells in the scheduled cells.

In an embodiment, the bit information is n consecutive bits in the first information field of the MC-DCI, and n is a positive integer. For example, the bit information is from the first bit to the nth bit in the first information field of the MC-DCI, or from the last bit to the nth to last bit in the first information field of the MC-DCI.

For example, n is set to 2, when the bit information is from the first bit to the nth bit in the first information field of the MC-DCI, one or more cells scheduled by the first information field in the MC-DCI is indicated by the first two bits of the first information field in the MC-DCI.

For example, n is set to 3, when the bit information is from the last bit to the penultimate nth bit in the first information field of the MC-DCI, one or more cells scheduled by the first information field in the MC-DCI is indicated by the last bit to the third to last bit of the first information field in the MC-DCI.

In an embodiment, instructing, based on the bit information in the MC-DCI, to determine one or more cells scheduled by the information field in the MC-DCI includes: determining, based on a correlation between a value of the bit information and a cell, and one or more cells scheduled by the information field in the MC-DCI, a target value in the correlation, and transmit the MC-DCI to the terminal.

The network device may pre-store the correlation between the value of the bit information and the cell. When instructing, the cell scheduled by the information field in the MC-DCI can be determined, and the target value corresponding to the cell scheduled by the information field in the MC-DCI can be determined in the correlation. The bit information in the MC-DCI is set to be equal to the determined target value, and the MC-DCI is transmitted to the terminal, so that the terminal can determine the value of bit information in the MC-DCI, and determine in the correlation that the cell corresponding to the value of bit information is one or more cells scheduled by the information field in the MC-DCI.

In an embodiment, the correlation between the value of the bit information and the cell includes: a positive correlation and a negative correlation.

There is a positive correlation between the value of the bit information and the identification of the cell, for example, the larger the value of bit information, the larger the identity of the cell scheduled by the first information field in the MC-DCI.

There is a negative correlation between the value of the bit information and the identity of the cell, for example, the larger the value of bit information, the smaller the identity of the cell scheduled by the first information field in the MC-DCI.

In an embodiment, in addition to the embodiment of determining one or more cells scheduled by a first information field in the MC-DCI based on the bit information in the MC-DCI, one or more cells scheduled by the first information field in the MC-DCI may be determined based on a predefined mode. For example, an identity of the scheduled cell may be determined, with the cell with the largest identity being the cell scheduled by the first information field in the MC-DCI, or the cell with the smallest identity being the cell scheduled by the first information field in the MC-DCI.

Corresponding to the embodiments of the method for determining the information field and the method for determining the cell, the present disclosure further provides embodiments of the apparatus for determining the information field and the apparatus for determining the cell.

FIG. 12 is a block diagram illustrating an apparatus for determining an information field according to an embodiment of the present disclosure. The apparatus for determining the information field shown in this embodiment may be a terminal or an apparatus composed of modules in the terminal. The terminal includes, but is not limited to, a communication device such as a cell phone, a tablet, a wearable device, a sensor, an internet of things (IoT) device, and the like. The terminal may communicate with a network device. The network device includes, but is not limited to a network device (such as a base station, a core network, and the like) in a communication system such as a 4th generation (4G) communication system, 5G communication system, 6G communication system, etc.

As shown in FIG. 12, the apparatus for determining the information field includes a processing module 1201.

The processing module 1201 is configured to determine a size of at least one information field in multi-cell downlink control information (MC-DCI) for scheduling multiple cells based on any one of: first configuration signaling; a predefined condition; and a size of at least one information field in legacy downlink control information transmitted to the terminal.

In an embodiment, the processing module is configured to determine, based on information configured for a first information field by first configuration signaling of a scheduling cell, a size of the first information field in the MC-DCI.

In an embodiment, the processing is configured to determine, based on a correlation between a predefined condition for a reference cell in cells capable of being scheduled by the MC-DCI and a number of bits, and the predefined condition, the size of the at least one information field in the MC-DCI.

In an embodiment, the processing module is configured to determine, based on information configured for a first information field by second configuration signaling of a reference cell in cells capable of being scheduled by the MC-DCI, a size of the first information field in the MC-DCI.

In an embodiment, the processing module is configured to determine that a size of a first information field in the MC-DCI is equal to a size of a first information field in the legacy downlink control information.

In an embodiment, the processing module is further configured to, in a case that a number of bits occupied by the first information field in the legacy downlink control information is fixed, determine that the size of the first information field in the MC-DCI is equal to the size of the first information field in the legacy downlink control information.

In an embodiment, the processing module is further configured to determine the reference cell based on the configuration signaling of the network device; or determine the reference cell based on the predefined mode.

In an embodiment, the predefined mode includes at least one of:
determining an upper limit value of a size of a first information field of each of at least one scheduled cell, and determining a scheduled cell corresponding to a maximum upper limit value as the reference cell;
determining a lower limit value of the size of the first information field of each of the at least one scheduled cell, and determining a scheduled cell corresponding to a minimum lower limit value as the reference cell;
determining an identity of each of the at least one scheduled cell, and determining a scheduled cell with the largest identity as the reference cell; or
determining the identity of each of the at least one scheduled cell, and determining a scheduled cell with the smallest identity as the reference cell.

In an embodiment, the terminal does not expect an indication value of a first information field in the MC-DCI to be greater than an upper limit value of an indication value of a first information field configured for each of at least one scheduled cell.

In an embodiment, indication information of a first information field in the MC-DCI is configured to schedule each of at least one scheduled cell, and the indication information is the same for each of the at least one scheduled cell.

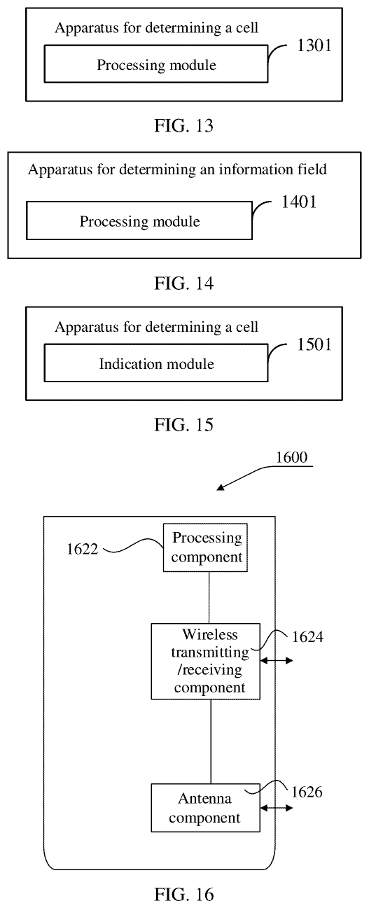

FIG. 13 is a block diagram illustrating an apparatus for determining a cell according to an embodiment of the present disclosure. The apparatus for determining the cell shown in this embodiment may be a terminal or an apparatus composed of modules in the terminal. The terminal includes, but is not limited to, a communication device such as a cell phone, a tablet, a wearable device, a sensor, an internet of things (IoT) device, and the like. The terminal may communicate with a network device. The network device includes, but is not limited to a network device (such as a base station, a core network, and the like) in a communication system such as a 4th generation (4G) communication system, 5G communication system, 6G communication system, etc.

As shown in FIG. 13, the apparatus for determining the cell includes a processing module 1301.

The processing module 1301 is configured to determine, based on bit information in multi-cell downlink control information (MC-DCI) for scheduling multiple cells, one or more cells scheduled by a first information field in the MC-DCI.

In an embodiment, the bit information is n consecutive bits in the first information field of the MC-DCI, and n is a positive integer.

In an embodiment, the processing module is configured to determine, based on a correlation between a value of the bit information and a cell, and the value of the bit information, one or more cells scheduled by the information field in the MC-DCI.

In an embodiment, the correlation between the value of the bit information and the cell includes:
a positive correlation between the value of the bit information and an identity of the cell; and
a negative correlation between the value of the bit information and an identity of the cell.

In an embodiment, indication information of the first information field in the MC-DCI is configured to schedule one or more cells.

FIG. 14 is a block diagram illustrating an apparatus for determining an information field according to an embodiment of the present disclosure. The apparatus for determining the information field shown in this embodiment can be a network device or an apparatus composed of modules in the network device, which can communicate with the terminal. The terminal includes, but is not limited to, a communication device such as a cell phone, a tablet, a wearable device, a sensor, an internet of things (IoT) device, and the like. The network device includes, but is not limited to a network device (such as a base station, a core network, and the like) in a communication system such as a 4th generation (4G) communication system, 5G communication system, 6G communication system, etc.

As shown in FIG. 14, the apparatus for determining the information field includes a processing module 1401.

The processing module 1401 is configured to determine a size of at least one information field in multi-cell downlink control information (MC-DCI), for scheduling multiple cells, transmitted to a terminal based on any one of: first configuration signaling; a predefined condition; and a size of at least one information field in legacy downlink control information transmitted to the terminal.

In an embodiment, the processing module is configured to determine, based on information configured for a first information field by first configuration signaling transmitted to the terminal at a scheduling cell for the terminal, a size of the first information field in the MC-DCI.

In an embodiment, the processing is configured to determine, based on a correlation between a predefined condition for a reference cell in cells capable of being scheduled by the MC-DCI and a number of bits, and the predefined condition, the size of the at least one information field in the MC-DCI.

In an embodiment, the processing module is configured to determine, based on information configured for a first information field by second configuration signaling transmitted to the terminal at a reference cell in cells capable of being scheduled by the MC-DCI, a size of the first information field in the MC-DCI.

In an embodiment, the processing module is configured to determine that a size of a first information field in the MC-DCI is equal to a size of a first information field in the legacy downlink control information.

In an embodiment, the processing module is further configured to, in a case that a number of bits occupied by the first information field in the legacy downlink control information is fixed, determine that the size of the first information field in the MC-DCI is equal to the size of the first information field in the legacy downlink control information.

In an embodiment, the apparatus further includes a transmitting module. The transmitting module is configured to instruct the terminal to determine, by the configuration signaling, the reference cell; or the processing module is configured to determine, by the predefined mode, the reference cell.

In an embodiment, the predefined mode includes at least one of:
determining an upper limit value of a size of a first information field of each of at least one scheduled cell, and determining a scheduled cell corresponding to a maximum upper limit value as the reference cell;
determining a lower limit value of the size of the first information field of each of the at least one scheduled cell, and determining a scheduled cell corresponding to a minimum lower limit value as the reference cell;
determining an identity of each of the at least one scheduled cell, and determining a scheduled cell with the largest identity as the reference cell; or
determining the identity of each of the at least one scheduled cell, and determining a scheduled cell with the smallest identity as the reference cell.

In an embodiment, indication information of a first information field in the MC-DCI is configured to schedule each of at least one scheduled cell, and the indication information is the same for each of the at least one scheduled cell.

FIG. 15 is a block diagram illustrating an apparatus for determining a cell according to an embodiment of the present disclosure. The apparatus for determining the cell shown in this embodiment can be a network device or an apparatus composed of modules in the network device, which can communicate with the terminal. The terminal includes, but is not limited to, a communication device such as a cell phone, a tablet, a wearable device, a sensor, an internet of things (IoT) device, and the like. The network device includes, but is not limited to a network device (such as a base station, a core network, and the like) in a communication system such as a 4th generation (4G) communication system, 5G communication system, 6G communication system, etc.

As shown in FIG. 15, the apparatus for determining the cell includes an indication module 1501.

The indication module 1501 is configured to instruct, by bit information in multi-cell downlink control information (MC-DCI) for scheduling multiple cells for a terminal, the terminal to determine one or more cells scheduled by a first information field in the MC-DCI.

In an embodiment, the bit information is n consecutive bits in the first information field of the MC-DCI, and n is a positive integer.

In an embodiment, the indication module is configured to determine, based on a correlation between a value of the bit information and a cell, and one or more cells scheduled by the information field in the MC-DCI, a target value in the correlation; and set the bit information in the MC-DCI to be equal to the target value, and transmit the MC-DCI to the terminal.

In an embodiment, the correlation between the value of the bit information and the cell includes:
a positive correlation between the value of the bit information and an identity of the cell; and
a negative correlation between the value of the bit information and an identity of the cell.

In an embodiment, indication information of the first information field in the MC-DCI is configured to schedule one or more cells.

With regard to the device in the above examples, the specific manner in which the respective modules perform the operations has been described in detail in the examples of the related methods, and will not be explained in detail herein.

Since the embodiments of the apparatus substantially corresponds to the embodiments of the method, relevant parts may be referred to the description of the embodiments of the method. The apparatus examples described above are merely illustrative, where the modules described as separate members may be or not be physically separated, and the members displayed as modules may be or not be physical units, i.e., may be located in one place, or may be distributed in a plurality of network modules. Part or all of the modules may be selected according to actual requirements to implement the objectives of the solutions in the examples. It may be understood and implemented by those skilled in the art without creative work.

According to a ninth aspect of the embodiments of the present disclosure, there is provided a system for determining an information field, including a terminal and a network device, where the terminal is configured to perform the method for determining the information field according to any one of the embodiments performed by the terminal, and the network device is configured to perform the method for determining the information field according to any one of the embodiments performed by the network device.

The embodiments of the present disclosure provide a system for determining a cell, including a terminal and a network device, where the terminal is configured to perform the method for determining the cell according to any one of the embodiments, and the network device is configured to perform the method for indicating the cell according to any one of the embodiments.

The embodiments of the present disclosure provide a communication device, including: a processor; and a memory storing computer programs, where the computer programs, when executed by the processor, cause the processor to perform the information field according to any one of the embodiments, and/or the method for determining the cell performed by the terminal according to any one of the embodiments.

The embodiments of the present disclosure provide a communication device, including: a processor; and a memory storing computer programs, where the computer programs, when executed by the processor, cause the processor to perform the method for determining the information field according to any one of the embodiments, and/or the method for indicating the cell performed by the network device according to any one of the embodiments.

The embodiments of the present disclosure provide a computer-readable storage medium, storing computer programs thereon, where the computer programs, when executed by a processor, cause the processor to perform the method for determining the information field according to any one of the embodiments, and/or the method for determining the cell performed by the terminal according to any one of the embodiments.

The embodiments of the present disclosure provide a computer-readable storage medium, storing computer programs thereon, where the computer programs, when executed by a processor, cause the processor to perform the method for determining the information field according to any one of the embodiments, and/or the method for indicating the cell performed by the network device according to any one of the embodiments.

FIG. 16 is a block diagram illustrating a device 1600 for determining an information field and/or indicating a cell according to an embodiment of the present disclosure. The device 1600 may be provided as a base station. Referring to FIG. 16, the device 1600 includes a processing component 1622, a wireless transmitting/receiving component 1624, an antenna component 1626, and a signal processing portion (not shown in the figures) specific to a wireless interface. The processing component 1622 may further include one or more processors. One of the processors in the processing component 1622 may be configured to perform the method for determining the information field and/or the method for indicating the cell performed by the network according to any one of the embodiments.

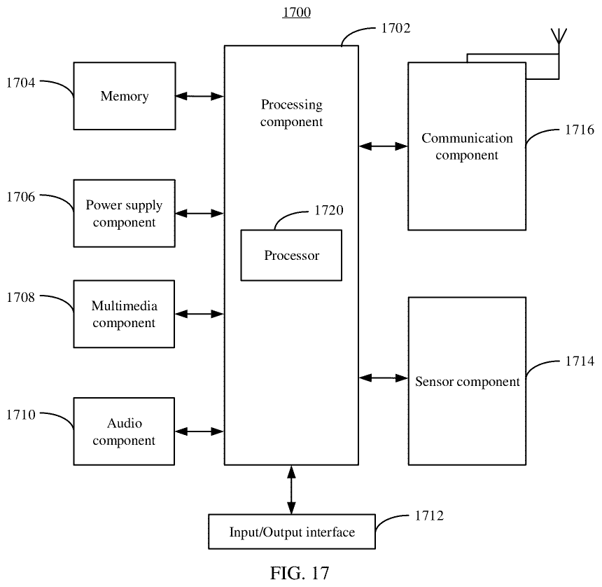

FIG. 17 is a block diagram illustrating a device 1700 for determining an information field and/or determining a cell according to an embodiment of the present disclosure. For example, the device 1700 can be a mobile phone, a computer, a digital broadcast terminal, a message transmitting and receiving device, a gaming console, a tablet device, a medical device, a fitness device, a personal digital assistant, and the like.

Referring to FIG. 17, the device 1700 can include one or more of the following components: a processing component 1702, a memory 1704, a power supply component 1706, a multimedia component 1708, an audio component 1710, an input/output (I/O) interface 1712, a sensor component 1714, and a communication component 1716.

The processing component 1702 usually controls overall operations of the device 1700, such as operations related to display, a telephone call, data communication, a camera operation and a record operation. The processing component 1702 may include one or more processors 1720 to execute instructions to complete all or a portion of the steps of the method for determining the information field and/or the method for determining the cell performed by the terminal according to any one of the embodiments. Further, the processing component 1702 may include one or more modules to facilitate interaction between the processing component 1702 and another component. For example, the processing component 1702 may include a multimedia module to facilitate the interaction between the multimedia component 1708 and the processing component 1702.

The memory 1704 is configured to store different types of data to support the operations of the device 1700. Examples of such data include instructions, contact data, phone book data, messages, pictures, videos, and so on for any application or method that operates on the device 1700. The memory 1704 may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a disk or optical disk.

The power supply component 1706 provides power for different components of the device 1700. The power supply component 1706 may include a power management system, one or more power sources, and other components associated with generating, managing and distributing power for the device 1700.

The multimedia component 1708 includes a screen for providing an output interface between the device 1700 and a user. In some embodiments, the screen may include a liquid crystal display (LCD) and/or a touch panel (TP). If the screen includes a touch panel, the screen may be implemented as a touch screen for receiving an input signal from a user. The touch panel may include one or more touch sensors for sensing a touch, a slide and a gesture on the touch panel. The touch sensor may not only sense a boundary of a touching or sliding movement, but also detect duration and pressure related to the touching or sliding operation. In some examples, the multimedia component 1708 may include a front camera and/or a rear camera. When the device 1700 is in an operation mode, such as a shooting mode or a video mode, the front camera and/or the rear camera can receive external multimedia data. Each of the front camera and the rear camera may be a fixed optical lens system or be of a focal length and a capability of an optical zoom.

The audio component 1710 is configured to output and/or input an audio signal. For example, the audio component 1710 may include a microphone (MIC). When the device 1700 is in an operating mode, such as a call mode, a recording mode and a speech recognition mode, the microphone is configured to receive an external audio signal. The received audio signal may be further stored in the memory 1704 or sent via the communication component 1716. In some embodiments, the audio component 1710 also includes a speaker for outputting an audio signal.

The I/O interface 1712 provides an interface between the processing component 1702 and a peripheral interface module which may be a keyboard, a click wheel, a button, or the like. Such buttons may include but not limited to: a home button, a volume button, a start button and a lock button.

The sensor component 1714 includes one or more sensors for providing state assessments in different aspects for the device 1700. For example, the sensor component 1714 can detect an open/closed state of the device 1700, a relative positioning of components, such as the display and keypad of the device 1700, and sensor component 1714 can also detect a change in position of the device 1700 or a component of the device 1700, the presence or absence of user contact with the device 1700, orientation or acceleration/deceleration of the device 1700, and temperature change of the device 1700. The sensor component 1714 may include a proximity sensor configured to detect presence of a nearby object without any physical contact. The sensor component 1714 may also include an optical sensor, such as a CMOS or CCD image sensor used in an imaging application. In some examples, the sensor component 1714 may also include an acceleration sensor, a gyro sensor, a magnetic sensor, a pressure sensor, or a temperature sensor.

The communication component 1716 is configured to facilitate wired or wireless communication between the device 1700 and other devices. The device 1700 may access a wireless network based on a communication standard, such as WiFi, 2G, 3G, 4G LTE, 5G NR, or a combination thereof. In some embodiments, the communication component 1716 may receive a broadcast signal or broadcast-related information from an external broadcast management system via a broadcast channel. In some embodiments, the communication component 1716 may also include a near field communication (NFC) module to facilitate short-range communications. For example, the NFC module may be implemented based on a radio frequency identification (RFID) technology, an infrared data association (IrDA) technology, an ultra wide band (UWB) technology, a Bluetooth (BT) technology, and other technologies.

In an exemplary example, device 1700 may be implemented by one or more application specific integrated circuits (ASICs), digital signal processors (DSPs), digital signal processing devices (DSPDs), programmable logic devices (PLDs), field programmable gate array (FPGA), controller, microcontroller, microprocessor or other electronic elements for performing the method for determining the information field and/or the method for determining the cell performed by the terminal according to any one of the embodiments.

According to the embodiments of the present disclosure, the terminal can determine the size of the information field in the MC-DCI based on the first configuration signaling transmitted by the scheduling cell, the second configuration signaling of the reference cell, the predefined condition of the second reference cell and the size of the information field in the legacy DCI, so as to determine the size of the information field in the MC-DCI, and thus determine the value of the information field, and determine the information indicated by the information field.

Moreover, the terminal can determine one or more cells scheduled by the first information field in the MC-DCI based on the bit information in the MC-DCI, so as to accurately determine that the first information field in the MC-DCI is specifically used for scheduling cells in the scheduled cells.

In an example, a non-transitory computer readable storage medium including instructions, such as the memory 1704 including instructions, is also provided. The above instructions may be executed by the processor 1720 of the device 1700 to complete the method for determining the information field and/or the method for determining the cell performed by the terminal according to any one of the embodiments. For example, the non-transitory computer readable storage medium may be a read-only memory (ROM), a random access memory (RAM), a CD-ROM, a magnetic tape, a floppy disk and an optical data storage device, etc.

After considering the specification and practicing the present disclosure, the persons of skill in the prior art may easily conceive of other implementations of the present disclosure. The present disclosure is intended to cover any variations, uses, modification or adaptations of the present disclosure that follow the general principles thereof and include common knowledge or conventional technical means in the art that are not disclosed in the present disclosure. The specification and examples are considered as exemplary only, with a true scope and spirit of the present disclosure being indicated by the following claims.

It is to be understood that the present disclosure is not limited to the precise construction described herein and shown in the drawings, and that various modifications and changes may be made without departing from the scope thereof. The scope of the disclosure is to be limited only by the appended claims.

It shall be noted that the relational terms such as “first” and “second” used herein are merely intended to distinguish one entity or operation from another entity or operation rather than to require or imply any such actual relation or order existing between these entities or operations. Also, the term “including”, “containing” or any variation thereof is intended to encompass non-exclusive inclusion, so that a process, method, article or device including a series of elements includes not only those elements but also other elements not listed explicitly or those elements inherent to such a process, method, article or device. Without more limitations, an element defined by the statement “including a . . . ” shall not be precluded to include additional same elements present in a process, method, article or device including the elements.

The methods and apparatuses of the present disclosure are described above in detail. The principle and implementation of the present disclosure are described herein through specific examples. The description about the embodiments of the present disclosure is merely provided for case of understanding of the method and core ideas of the present disclosure. Persons of ordinary skill in the art can make variations and modifications to the present disclosure in terms of the specific implementations and application scopes according to the ideas of the present disclosure. Therefore, the specification shall not be construed as a limit to the present disclosure.

1.-65. (canceled)

66. A method for determining an information field, performed by a terminal, and comprising:
determining, based on at least one of a predefined mode or configuration signaling, a size of at least one information field in multi-cell downlink control information (MC-DCI) for scheduling multiple cells.

67. The method of claim 66, further comprising:
receiving the configuration signaling in a scheduling cell.

68. The method of claim 66, further comprising:
receiving the configuration signaling in a scheduled cell, wherein the scheduled cell includes one or more of multiple scheduled cells capable of being scheduled by the MC-DCI.

69. The method of claim 66, wherein the configuration signaling is radio resource control (RRC) signaling.

70. The method of claim 66, wherein determining, based on the predefined mode, the size of the at least one information field in the MC-DCI comprises:
determining, based on a size of a first information field in legacy downlink control information, a size of the first information field in the MC-DCI.

71. The method of claim 66, further comprising:
determining a cell to which a first information field in the MC DCI is capable of being applied, wherein the cell is a cell, with a smallest cell identity, in the multiple cells scheduled by the MC-DCI.

72. A method for determining an information field, performed by a network device, and comprising at least one of:
determining, based on a predefined mode, a size of at least one information field in multi-cell downlink control information (MC-DCI) for scheduling multiple cells; or
transmitting configuration signaling to a terminal, wherein the configuration signaling is configured to indicate to the terminal the size of at least one information field in the MC-DCI.

73. The method of claim 72, further comprising:
transmitting the configuration signaling to the terminal in a scheduling cell.

74. The method of claim 72, further comprising:
transmitting the configuration signal to the terminal in a scheduled cell, wherein the scheduled cell includes one or more of multiple scheduled cells capable of being scheduled by the MC-DCI.

75. The method of claim 72, wherein the configuration signaling is radio resource control (RRC) signaling.

76. The method of claim 72, wherein determining, based on the predefined mode, the size of the at least one information field in the MC-DCI comprises:
determining, based on a size of a first information field in legacy downlink control information, a size of the first information field in the MC-DCI.

77. The method of claim 72, further comprising:
determining a cell to which a first information field in the MC DCI is capable of being applied, wherein the cell is a cell, with a smallest cell identity, in the multiple cells scheduled by the MC-DCI.

78. A terminal, comprising:
a processor; and
a memory storing instructions executable by the processor;
wherein the processor is configured to:
determine, based on at least one of a predefined mode or configuration signaling, a size of at least one information field in multi-cell downlink control information (MC-DCI) for scheduling multiple cells.

79. A network device, comprising:
a processor; and
a memory storing instructions executable by the processor;
wherein the processor is configured to perform the method of claim 72.

80. A non-transitory computer-readable storage medium storing instructions thereon, wherein the instructions, when executed by a processor, cause the processor to perform the method of claim 66.

81. A non-transitory computer-readable storage medium storing instructions thereon, wherein the instructions, when executed by a processor, cause the processor to perform the method of claim 72.
